(19) United States
(12) Patent Application Publication
(10) Pub. No.: US 2025/0016860 A1
(43) Pub. Date: Jan. 9, 2025

(54) COMMUNICATION METHODS AND DEVICE TO MANAGE ELIGIBLE ENHANCED MULTI-LINK MULTI-RADIO LINKS

(71) Applicant: CANON KABUSHIKI KAISHA, Tokyo (JP)

(72) Inventors: Mickaël LORGEOUX, RENNES (FR); Julien SEVIN, LANGAN (FR)

(21) Appl. No.: 18/713,116

(22) PCT Filed: Dec. 13, 2022
(86) PCT No.: PCT/EP2022/085489

§ 371 Date: May 23, 2024

(30) Foreign Application Priority Data
Dec. 13, 2021 (GB) 2118032.8

(51) Int. Cl. H04W 76/15

(52) U.S. Cl. CPC H04W 76/15

(57) ABSTRACT

In wireless networks implementing multilink transmissions, a non-AP MLD declares EMLMR capabilities in a ML Association Request, with a set of eligible EMLMR links. Eligible EMLMR links form part or all of the candidate links for set up with an AP MLD. The latter replies with a ML Association Response setting up candidate links and signalling which eligible EMLMR links are accepted. The signalling may involve a Status Code per each link. In operation, the non-AP MLD sends one or more EML OM Notification frames requesting an activation of an EMLMR mode. Such a frame includes an EML Link bitmap specifying the EMLMR links set to be used. Two EMLMR modes with two separate and disjoint EMLMR links sets can then be activated simultaneously.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between stations.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11 be or EHT for “Extremely High Throughput”.

The IEEE P802.11be/D1.3 version (November 2021, below “D1.3 standard”) includes the so-called Multi-Link (ML) Operation (MLO). MLO improves data throughput by allowing communications between stations over multiple concurrent and non-contiguous communication links.

MLO enables a non-AP (Access Point) MLD (ML Device) to register with an AP MLD, i.e. to discover, authenticate, associate and set up multiple links with the AP MLD. Each link enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP MLD can use 802.11 mechanisms to communicate with affiliated stations of another MLD over each of the multiple communication links that are set up.

With the introduction of MLO and of spatial multiplexing capabilities of the MLDs, new Operating Modes (OM), referred to as Enhanced Multi-Link Operating Mode (EML OM), have been introduced in the D1.3 standard, namely the EMLSR (Enhanced Multi-Link Single Radio) mode and the EMLMR (Enhanced Multi-Link Multi-Radio) mode.

In the EMLSR mode, a non-AP MLD is able to simultaneously listen to a set of enabled links (so-called EMLSR links) for receiving initial control frame (e.g. MU-RTS, BSRP) from the AP MLD and can, however, perform data frames exchange with the AP MLD over only one link at a time, usually the link over which the initial control frame has been received.

In the EMLMR mode, a non-AP MLD is able to aggregate some physical resources of multiple radios dedicated to multiple enabled links (so-called EMLMR links), in order to transmit or receive data up to a pre-defined number of supported Rx/Tx spatial streams. This predefined number is higher than the number of supported Rx/Tx spatial streams per each radio, hence providing throughput enhancement and latency reduction. As an example, a multi-radio (MR) non-AP MLD supporting the EMLMR mode on two links (with associated radios) communicates over the two links using the two respective radios when the EMLMR mode is deactivated, for example in a 2×2 MIMO antenna configuration for each radio. On the other hand, the MR non-AP MLD communicates over one of the two links using one of its radios with the aggregated physical resources of the two radios (typically the antennas) when the EMLMR mode is activated, for example in a 4×4 MIMO antenna configuration. In the same time, the other link (deprived of its physical antenna) cannot be used.

The non-AP MLDs declare their support for each of the EML Operating Modes (known as EML Capabilities) to the AP MLD, during the association phase. In the D1.3 standard, the two EMLSR and EMLMR modes are mutually exclusive.

In operation mode, the activation (so-called “Initiation”) and the deactivation (so-called “Termination”) of an EML Operation Mode is initiated by the non-AP MLD which sends a specific EHT action frame referred to as “EML OM Notification”. The EML OM Notification frame includes one bit for each of the EMLSR mode and the EMLMR mode, in order to signal which mode is concerned by the activation or deactivation. In the D1.3 standard, the EML OM Notification frame further comprises, should an activation of the EMLSR mode be requested, an EMLSR Link bitmap specifying the set of enabled links, called EMLSR Links, in which the EMLSR mode is applied.

Such current activation/deactivation scheme is not fully satisfactory in particular with respect of the EMLMR mode. Indeed, not all the links can support such mode (due to aggregation requirements) while the EMLMR mode may involve or apply to various sets of links. A better management of the wireless network is thus sought.

### SUMMARY OF INVENTION

It is a broad objective of the present invention to overcome some of the foregoing concerns.

Embodiments of the invention are defined in the claims.

A communication method in a wireless network, comprises at a requesting multi-link device, MLD: sending, to a requested MLD, an Enhanced Multi-Link, EML, Operating Mode, OM, notification frame including an EML Control field, the EML Control field comprising an EML Mode subfield set to indicate that an EML mode is disabled for a set of EML links. The communication method further comprises selecting a link from the set of EML links for which the EML mode is disabled. The notification frame is sent over the link selected from the set of EML links for which the EML mode is disabled.

Correspondingly, a communication method in a wireless network, comprises at a requested multi-link device, MLD:
receiving, from a requesting MLD, an Enhanced Multi-Link, EML, Operating Mode, OM, notification frame including an EML Control field, the EML Control field comprising an EML Mode subfield set to indicate that an EML mode is disabled for a set of EML links; and
determining the set of EML links for which the EML mode is disabled based on the link over which the EML OM notification frame is received.

In some embodiments, prior to the sending, the EML mode is enabled for the set of EML links.

In other embodiments, prior to the sending, the EML mode is enabled simultaneously for a plurality of sets of EML links, including the set of EML links for which the EML mode is disabled. For example, the plurality of sets of EML links are disjoint sets of EML links.

In practice, the EML mode is enabled for a target set of EML links by sending, to the requested MLD, an EML OM notification frame that includes an EML Control field, the EML Control field comprising an EML Mode subfield set to indicate that the EML mode is enabled for the target set of EML links and a bitmap subfield specifying the target set of EML links. Conversely, the requested MLD receives such EML OM notification frame or frames to enable one or more set of EML links.

In some embodiments, the EML OM notification frame is deprived of a bitmap specifying the set of EML links for which the EML mode is disabled.

In some embodiments, the EML mode is one of an EML Multi-Radio, MR, mode or an EML Single-Radio, SR, mode. For instance, the EML Control field may include an EMLMR Mode subfield and an EMLSR Mode subfield, and the EMLMR, respectively EMLSR, Mode subfield may be set to 0 to indicate that an EMLMR, respectively EMLSR, mode is disabled.

In some embodiments, the communication method further comprises setting up links between the requesting and requested MLDs and enabling setup links, wherein the links in the set of EML links are enabled links.

Another communication method in a wireless network, comprises at a requesting multi-link device, MLD, sending, to a requested MLD, multiple Enhanced Multi-Link, EML, Operating Mode, OM, notification frames, each including an EML Control field, the EML Control field comprising an EML Mode subfield set to indicate that an EML mode is enabled for a set of EML links and a bitmap subfield specifying the set of EML links. The EML mode is enabled simultaneously for two or more sets of EML links provided that these two or more sets of EML links are disjoint.

Correspondingly, a communication method in a wireless network, comprises at a requested multi-link device, MLD, receiving, from a requesting MLD, multiple Enhanced Multi-Link, EML, Operating Mode, OM, notification frames, each including an EML Control field, the EML Control field comprising an EML Mode subfield set to indicate that an EML mode is enabled for a set of EML links and a bitmap subfield specifying the set of EML links. Again, the EML mode is enabled simultaneously for two or more sets of EML links provided that these two or more sets of EML links are disjoint.

In some embodiments, the EML mode is one of an EML Multi-Radio, MR, mode or an EML Single-Radio, SR, mode. For instance, the EML Control field may include an EMLMR Mode subfield and an EMLSR mode subfield, and the EMLMR, respectively EMLSR, Mode subfield may be set to 1 to indicate that an EMLMR, respectively EMLSR, mode is enabled.

A requesting or requested Multi-Link Device, MLD, comprises a memory and a processing circuitry coupled to the memory. The processing circuitry is configured to perform the steps as defined above.

Another improved management of the wireless network may regard a communication method in a wireless network, comprising at a requesting multi-link device, MLD, e.g. a non-access point, non-AP, MLD:
sending, to a requested MLD, e.g. an AP MLD, a capability declaration that the requesting MLD supports Enhanced Multi-Link, EML, operations, wherein when the capability declaration declares support of EML Multi-Radio, MR, operations, it further declares (or signals) a set of eligible EMLMR links in which applying the EMLMR operations, and
subsequently sending, to the requested MLD, one or more EML Operating Mode, OM, notification frames, each requesting an activation or deactivation of an EML OM, wherein an EML OM notification frame requesting an activation of an EMLMR mode includes a bitmap specifying an EMLMR links set made of eligible EMLMR links, in which to apply the EMLMR mode.

Correspondingly, a communication method in a wireless network, comprising at a requested multi-link device, MLD, e.g. an access point, AP, MLD:
receiving, from a requesting MLD, e.g. a non-AP MLD, a capability declaration that the requesting MLD supports Enhanced Multi-Link, EML, operations, wherein when the capability declaration declares support of EML Multi-Radio, MR, operations, it further declares (or signals) a set of eligible EMLMR links in which applying the EMLMR operations, and
subsequently receiving, from the requesting MLD, one or more EML Operating Mode, OM, notification frames, each requesting an activation or deactivation of an EML OM, wherein an EML OM notification frame requesting an activation of an EMLMR mode includes a bitmap specifying an EMLMR links set made of eligible EMLMR links, in which to apply the EMLMR mode.

The way of signaling the EMLMR links in two steps eases the management of multiple EMLMR links sets that non-AP MLD can use alternatively in operation. Indeed, the latter can first declare all the eligible EMLMR links it intends to use for its various operations in EMLMR modes. This allows for instance the AP MLD to negotiate the eligible EMLMR links given the radio aggregation constraints, as described below. Then, it can specify which ones from them are actually used for a given activation of the EMLMR mode. This indeed allows the non-AP MLD to use whatever EMLMR links set based on the declared eligible EMLMR links.

The above-mentioned negotiation may for example implement receiving a capability response from the requested MLD signaling which of the eligible EMLMR links support or not EMLMR operations. In that case, the links in the EMLMR links set are selected from the eligible EMLMR links supporting EMLMR operations. From requested MLD perspective, it may implement determining, for each of the (declared) eligible EMLMR links, whether it supports or not EMLMR operations. For instance, this may mean for an AP MLD to check whether the corresponding affiliated AP (i.e. involved in the eligible EMLMR link) supports EMLMR operations, i.e. aggregation of radio resources, and then sending, to the requesting MLD, a capability response signaling which of the eligible EMLMR links support or not EMLMR operations as determined. In that case, the links in the EMLMR links set (in the bitmap of the received EML OM notification frame) are selected from the eligible EMLMR links supporting EMLMR operations.

Such negotiation also overcomes some of the foregoing concerns, independently to the subsequent management of multiple EMLMR links sets. In this context, embodiments of the invention also provide a communication method in a wireless network, comprising at a requesting multi-link device, MLD, e.g. a non-access point, non-AP, MLD:
sending, to a requested MLD, e.g. an AP MLD, a capability declaration that the requesting MLD supports Enhanced Multi-Link, EML, operations, wherein when the capability declaration declares support of EML Multi-Radio, MR, operations, it further declares a set of eligible EMLMR links in which applying the EMLMR operations, and
receiving, from the requested MLD, a capability response signaling which of the eligible EMLMR links support or not EMLMR operations.

Correspondingly, a communication method in a wireless network, comprising at a requested multi-link device, MLD, e.g. an access point, AP, MLD:
receiving, from a requesting MLD, e.g. a non-AP MLD, a capability declaration that the requesting MLD supports Enhanced Multi-Link, EML, operations, wherein when the capability declaration declares support of EML Multi-Radio, MR, operations, it further declares a set of eligible EMLMR links in which applying the EMLMR operations,
determining, for each of the eligible EMLMR links, whether it supports or not EMLMR operations, and
sending, to the requesting MLD, a capability response signaling which of the eligible EMLMR links support or not EMLMR operations as determined.

Thanks to this innovative process, the AP MLD can negotiate the eligible EMLMR links with the requesting MLDs, considering the radio aggregation constraints, to ensure the subsequent activation of EMLMR modes by the requesting MLDs are fully operative. Hence, a better management of the wireless network is obtained.

Indeed, this approach can also be combined with the above approach of subsequent notification frames, meaning the process at the requesting MLD may also implement subsequently sending, to the requested MLD, one or more EML Operating Mode, OM, Notification frames, each requesting an activation or deactivation of an EML OM, wherein an EML OM frame requesting an activation of an EMLMR mode includes a bitmap specifying an EMLMR links set made of eligible EMLMR links that support EMLMR operations, in which to apply the EMLMR mode.

From requested MLD perspective, it may implement subsequently receiving such EML OM notification frames.

Optional features are defined below with reference to a method, while they can be transposed into device features.

As an example, the capability exchanges may occur during association of the requesting MLD to the requested MLD. In that case, the capability declaration may be included in a multi-link, ML, association request sent by the requesting MLD to the requested MLD.

Furthermore, the capability response may be included in an ML association response sent by the requested MLD to the requesting MLD in response to the ML association request.

In some embodiments, the capability declaration includes a bitmap specifying which links from a set of candidate links are eligible EMLMR links in which applying the EMLMR operations.

The candidate links may be those the requesting MLD wishes to set up with the requested MLD. In that case, the set of candidate links may be signaled in the same frame as the capability declaration, to set up links with the requested MLD.

Therefore, with a single frame, e.g. Association Request frame, the requesting MLD can request establishing links with the requested MLD and defining which of these links are desired (eligible) for EMLMR operations.

In some embodiments, a set of candidate links is signaled in the same frame as the capability declaration, to set up links with the requested MLD, and
in the absence, in the frame, of a bitmap specifying which links from the set of candidate links are eligible EMLMR links, the set of eligible EMLMR links is made of the set of candidate links. In other words, all the candidate links are eligible EMLMR links.

In some embodiments, the method further comprises setting up links between the requesting and requested MLDs and enabling setup links, wherein the links in the EMLMR links set are enabled links. The setting up of the links can be based on the candidate links mentioned above.

According to the D1.3 standard, a setup link is a link established between the two MLDs after ML association procedure, whereas an enabled link is such a setup link that has a Traffic Identifier, TID, mapped on it, i.e. that can be used to convey data with said TID.

In some embodiments, the EMLMR mode applying in the EMLMR links set is active at the same time as another EMLMR mode applying in a separate EMLMR links set between the (same) requesting and requested MLDs. For example, the two EMLMR modes applying in the two separate EMLMR links set may be activated simultaneously by simultaneously sending/receiving corresponding activation EML OM notification frames over the same or different links.

This shows that in some embodiments, the EMLMR links set is a subset of the eligible EMLMR links, or a subset of the enabled links declared as eligible EMLMR links (i.e. that support EMLMR operations).

In some embodiments, a set of candidate links is signaled in the same frame as the capability declaration, to set up links between the requesting and requested MLDs, and the capability response signals which of the eligible EMLMR links support or not EMLMR operations by using a status code associated with each of the candidate links. For example, during association, a response to each candidate link proposed by a non-AP MLD for setting up links is provided in the (Association Response) frame body for the link (called reporting link) over which the exchanges are made and in Per-STA Profiles of a Basic Variant ML element for each of the other links (called reported links). Such response, made of a status code, is here enhanced to further signal whether each eligible EMLMR link (i.e. corresponding affiliated AP) indeed supports the radio resource aggregation for EMLMR operations. This means the status code further indicates whether the candidate link is accepted to set up a link (between the two MLDs).

In variants, the capability response includes a bitmap signaling which links from a set of candidate links support EMLMR operations and which links do not support EMLMR operations. Preferably, the candidate links are signaled in the same frame as the capability declaration as mentioned above. However, this is not mandatory: they may be predefined.

Such additional bitmap allows the AP MLD to signal which of its affiliated APs (i.e. corresponding eligible EMLMR links) indeed support the aggregation of radio resources in order to be able to apply the EMLMR mode, while keeping a conventional Status Code signaling. It means that a status code associated with each of the candidate links further indicates whether the candidate link is accepted to set up a link.

In some embodiments, determining whether an eligible EMLMR link supports EMLMR operations includes determining whether the eligible EMLMR link (i.e. the radio of the corresponding affiliated AP) supports a number of receive (Rx) or transmit (Tx) spatial streams specified by the requesting MLD in the capability declaration.

In some embodiments, an EML OM Notification frame includes a first field set to activate or deactivate an EMLSR or EMLMR mode and a bitmap field comprising a bitmap of links, wherein the bitmap of links comprises:
when the first field activates an EMLSR mode, a set of enabled links in which the EMLSR mode is applied, or
when the first field activates an EMLMR mode, a set of enabled links in which the EMLMR mode is applied.

Correlatively, the invention also provides a wireless communication device comprising at least one microprocessor configured for carrying out the steps of any of the above methods. The wireless communication device may be either of a non-AP MLD and an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions;

FIG. 2 illustrates a Basic variant Multi-Link Element as specified in the D1.3 standard;

FIG. 3a illustrates the format of an EML Control field forming an EML OM Notification frame used to activate or deactivate an EML OM as defined in the IEEE P802.11 be/D1.1 standard;

FIG. 3b illustrates an alternative format of the EML Control field as defined in the D1.3 standard;

FIG. 4 schematically illustrates an exemplary sequence of EML OM Management frames for activating or deactivating an EML Operating Mode as specified in the D1.3 standard;

FIG. 5 illustrates a Basic variant Multi-Link Element with a modified EML capabilities subfield according to embodiments of the invention.

FIG. 6 schematically illustrates an exemplary sequence of management frames for operating the ML discovery and ML setup procedure according to embodiments of the invention;

FIGS. 7a to 7c illustrate alternative formats of an EML Control field according to embodiments of the invention;

FIG. 8 illustrates, using flowcharts, message exchanges to manage eligible EMLMR links when activating an EMLMR mode according to embodiments of the invention;

FIGS. 9a and 9b schematically illustrate an EML OM Management to refuse a requested activation or deactivation of an EML Operating Mode, according to embodiments of the invention;

FIGS. 10a and 10b schematically illustrate an EML OM Management where the AP MLD spontaneously suggests an activation of an EML OM, according to embodiments of the invention;

FIG. 11 schematically illustrates an EML OM Management where the AP MLD spontaneously suggests a deactivation of a currently active EML OM, according to embodiments of the invention;

FIG. 12 schematically illustrates an EML OM Management where the AP MLD spontaneously suggests a modification of a currently active EML OM, according to embodiments of the invention;

FIG. 13 schematically illustrates an EML OM Management where the AP MLD is solicited to indicate which set of links is to be used for an EML OM to activate, according to embodiments of the invention;

FIG. 14 schematically illustrates an EMLMR capable architecture for an MLD to implement embodiments of the invention; and

FIG. 15 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi (RTM) networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11 be/D1.3 of November 2021, introduce the Multi-Link Operation (MLO) when it comes to MAC layer operation. The MLO allows multi-link devices to establish or setup multiple links and operate them simultaneously.

A Multi-Link Device (MLD) is a logical entity and has more than one affiliated station (STA) and has a single medium access control (MAC) service access point (SAP) to logical link control (LLC), which includes one MAC data service. An Access Point Multi-Link Device (or AP MLD) then corresponds to a MLD where each station (STA) affiliated with the MLD is an AP, hence referred to as “affiliated AP”. A non-Access Point Multi-Link Device (or non-AP MLD) corresponds to a MLD where each station (STA) affiliated with the MLD is a non-AP STA, referred to as “affiliated non-AP station”. Depending on the literature, “multilink device”, “ML Device” (MLD), “multilink logical entity”, “ML logical entity” (MLE), “multilink set” and “ML set” are synonyms to designate the same type of ML Device.

Multiple affiliated non-AP stations of a non-AP MLD can then setup communication links with multiple affiliated APs of an AP MLD, hence forming a multi-link channel.

The links established for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP stations operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated stations but not necessary a number equal to its number of affiliated stations. In particular, a non-AP MLD may operate with a number of affiliated stations greater than its number of radios (which can even be reduced to a single one).

Several Enhanced Multi-Link Operating Modes (or EML OMs in short) can be defined from this physical architecture. P802.11be/D1.3 currently specifies two EML OMs for a non-AP MLD.

A first one, so-called EMLSR (Enhanced Multi-Link Single Radio) mode, is an operating mode wherein a non-AP MLD is able to listen to a set of links (so-called EMLSR links) simultaneously for the reception of initial control frames (e.g. MU-RTS, BSRP) transmitted by an AP MLD and can however perform data frames exchange with the AP MLD over only one link at a time (usually corresponding to the link wherein the initial control frame has been emitted).

A second one, so-called EMLMR (Enhanced Multi-Link Multi-Radio) mode, is an operating mode wherein a non-AP MLD is able to aggregate some physical resources of its different radios used on different links (so-called EMLMR links) in order to transmit or receive data up to a pre-defined number of supported Rx/Tx spatial streams, which number may be greater than the number of supported Rx/Tx spatial streams of each radio.

As defined in the D1.3 standard, each non-AP MLD may support either no EML operating mode or only one of the EMLSR and EMLMR mode. Although the D1.3 standard requires the EMLSR and EMLMR modes be mutually exclusive, alternative embodiments may contemplate having a non-AP MLD supporting both modes.

An AP MLD can usually support both EMLSR and EMLMR modes. In particular, it may simultaneously operate the two modes with two separate non-AP MLDs.

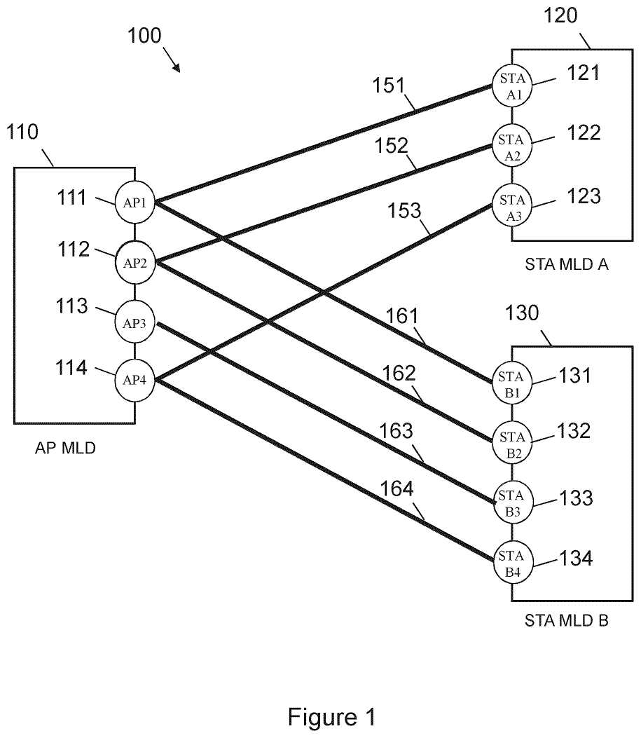

FIG. 1 illustrates a typical 802.11 network environment involving ML transmissions in which the present invention may be implemented.

Wireless communication network 100 involves an AP MLD 110 and two non-AP MLDs 120 and 130. Of course, another number of non-AP MLDs registering to the AP MLD 110 and then exchanging frames with it may be contemplated.

AP MLD 110 has multiple affiliated APs, four affiliated APs 111, 112, 113 and 114 (also referenced AP1, AP2, AP3, AP4 respectively) in the exemplary Figure, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP stations, each of which behaves as an 802.11 non-AP station in a BSS (managed by one of the affiliated APs 111, 112, 113, 114) to which it registers. In the exemplary Figure, three non-AP STAs 121, 122 and 123 (also referenced A1, A2, A3 respectively) are affiliated with non-AP MLD 120 and four non-AP STAs 131, 132, 133 and 134 (also referenced B1, B2, B3 and B4 respectively) are affiliated with non-AP MLD 130.

For illustrative purpose, non-AP MLDs 120 and 130 are multi-radio non-AP MLDs. For example, AP 111 is set to operate on channel 10 corresponding to an operating 20 MHz channel in the 2.4 GHz frequency band, AP 112 is set to operate on channel 36-40 corresponding to an operating 40 MHz channel in the 5 GHz frequency band, AP 113 is set to operate on channel 149-153 corresponding to an operating 40 MHz channel in the 5 GHz frequency band too, and AP 114 is set to operate on channel 301 corresponding to an operating 160 MHz channel in the 6 GHz frequency band. In this example, the affiliate stations operate on various frequency bands.

Each affiliated AP offers a link towards the AP MLD 110 to the affiliated non-AP stations. Hence, the links for each non-AP MLD can be merely identified with the identifiers of the respective affiliated APs. In this context, each of the affiliated APs 111-114 can be identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP station of the non-AP MLD. Each link enables individual channel access and frame exchanges between the non-AP MLD and the AP MLD based on supported capabilities exchanged during association.

The discovery phase is referred below to as ML discovery procedure, and the multi-link setup phase (or association phase) is referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate links between its own affiliated non-AP stations and some of the discovered affiliated APs and to request the AP MLD 110 to set up these links, which may be accepted or refused by the AP MLD. Management frames are used to that end, for instance ML Association Request frames. If the candidate links are accepted, the non-AP MLD is provided with an Association Identifier (AID) by the AP MLD, which AID is used by the affiliated non-APs of the non-AP MLD to wirelessly communicate over the multiple links (communication channels) with their corresponding affiliated APs. The selected and then accepted multiple links are referred to as setup links. Furthermore, such a link, that is setup as part of a multi-link setup, is defined as “enabled” if that link can be used for frame exchange and at least one Traffic Identifier (TID) is mapped to that link. A setup link is defined as disabled if no TID is mapped to that link. By default, in embodiments, as TIDs are mapped to all setup links, all setup links shall be enabled immediately after the association procedure.

For illustrative purpose, in wireless communication network 100, three candidate links have been requested by non-AP MLD 120 to AP MLD 110 and have been accepted by AP MLD 110: a first setup link 151 between affiliated AP 111 (AP1) and affiliated non-AP STA 121 (A1), a second setup link 152 between affiliated AP 112 (AP2) and affiliated non-AP STA 122 (A2), and a third setup link 153 between affiliated AP 114 (AP4) and affiliated non-AP STA 123 (A3).

Similarly, four candidate links have been requested by multi-radio non-AP MLD 130 to AP MLD 110 and have been accepted by AP MLD 110: a first setup link 161 between affiliated AP 111 (AP1) and affiliated non-AP STA 131 (B1), a second setup link 162 between affiliated AP 112 (AP2) and affiliated non-AP STA 132 (B2), a third setup link 163 between affiliated AP 113 (AP3) and affiliated non-AP STA 133 (B3) and a fourth setup link 164 between affiliated AP 114 (AP4) and affiliated non-AP STA 134 (B4).

During the ML setup procedure, the non-AP MLDs also declare part or all of their capabilities. For instance, they may declare their EMLSR capability and/or EMLMR capability. As described below, appropriate fields are provided in the management frames, for instance in the ML Association Request frame.

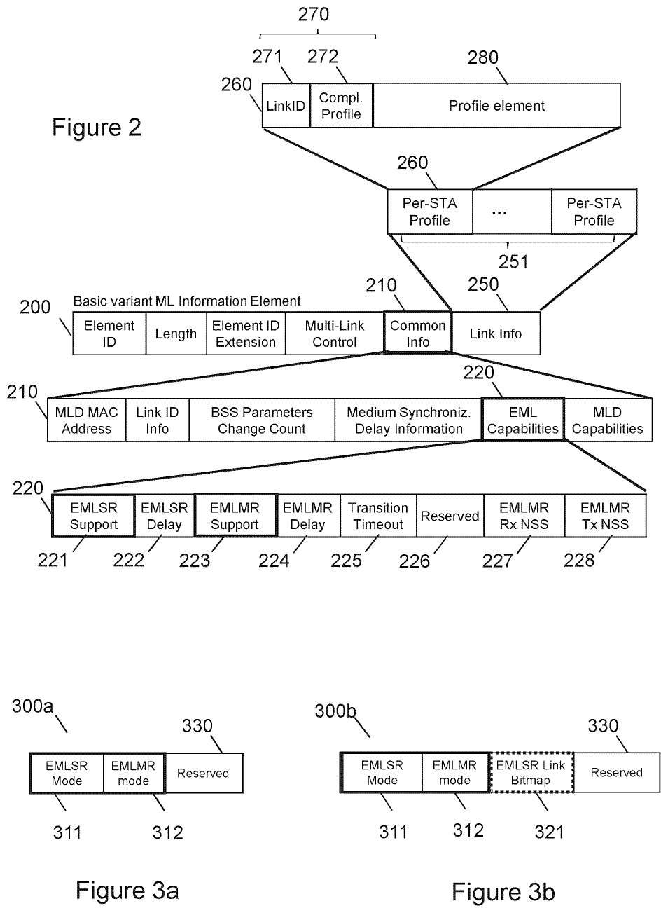

The management frames exchanged during the ML discovery and ML setup procedures contain new multi-link (ML) Information Elements specific to the Multi-Link Operation (MLO), referred to as Multi-Link elements. In particular, the ML Association request frame exchanged during the setup procedure is an Association Request frame as defined in 802.11 ax (for example IEEE P802.11ax/D8.0 of October 2020) augmented with a Basic variant Multi-Link element 200 as illustrated in FIG. 2 and defined in IEEE P802.11 be/D1.3 in which the non-AP MLD can request the candidate links (to set up links) and declare its EMLSR/EMLMR capabilities.

The 802.11ax fields of the Association Request frame are used in a conventional way, for instance to request the association of an affiliated non-AP station (e.g. B1 131) with an addressee affiliated AP (e.g. AP1 111). This defines a first requested candidate link defined between the affiliated non-AP station and an affiliated AP addressee of the ML Association Request frame.

Basic variant Multi-Link element 200 includes Element ID field, Length field (enabling to know the presence or not of the optional fields as well as the number of Per-STA profiles in field), Element ID Extension field, Multi-Link Control field, optional Common Info field 210 and optional Link Info field 250.

Link Info field 250 indicates the other candidate links that are requested for setup. Link Info field 250 is made of a set 251 of Per-STA Profile subelements 260, each Per-STA Profile element 260 defining one of the other requested candidate links.

A candidate link is defined between an affiliated AP of the AP MLD and an affiliated non-AP station of the non-AP MLD. Link ID subfield 271 of the Per-STA Profile is set to the Link ID of the affiliated AP corresponding to the candidate link concerned. Complete Profile subfield 272 is set to 1 and Profile Element subfield 280 includes all the network information elements of the affiliated non-AP station corresponding to the candidate link concerned.

Multi-Link Control field includes a Presence Bitmap subfield indicating which subfields are included in Common Info field 210.

According to the values specified in the Presence Bitmap subfield, Common Info field 210 includes optionally a MLD MAC Address subfield, a Link ID Info subfield, a BSS Parameters Change Count subfield, a Medium Synchronization Delay Information subfield, an EML Capabilities subfield 220 and a MLD Capabilities subfield.

EML Capabilities subfield 220 is used to declare the non-AP MLD's capabilities in terms of enhanced multi-link, in particular regarding EMLSR and EMLMR. It includes an EMLSR Support subfield 221, an EMLSR Delay subfield 222, an EMLMR Support subfield 223, an EMLMR Delay subfield 224, a Transition Timeout subfield 225, a Reserved subfield 226, an EMLMR Rx NSS subfield 227 and an EMLMR Tx NSS subfield 228.

EMLSR Support subfield 221, preferably a one-bit subfield, indicates support of the EMLSR operation for the MLD. EMLSR Support field 251 is set to 1 if the MLD supports the EMLSR operation; otherwise it is set to 0. EMLSR Delay subfield 222 indicates the MAC padding duration of the Padding field of the initial Control frame.

EMLMR Support subfield 223, preferably a one-bit subfield, indicates support of the EMLMR operation for the MLD. EMLMR Support field is set to 1 if the MLD supports the EMLMR operation; otherwise it is set to 0. EMLMR Delay subfield 224 indicates the minimum padding duration required for a non-AP MLD for EMLMR link switch when operating in EMLMR mode.

Transition Timeout subfield 225 indicates the maximum timeout value for activating (or initiating) or deactivation (or terminating) an EML OM, from the EML Operating Mode Notification frame exchange.

EMLMR Rx NSS and EMLMR Tx NSS subfields 227, 228 indicate the maximum receive and transmit Nss (Number of spatial streams) respectively, that are supported by the non-AP MLD in the EMLMR mode.

More details on these fields can be found in the D1.3 standard.

In a scenario not covered by the D1.3 standard, non-AP MLDs 120 and 130 support both the EMLSR mode and the EMLMR mode. Hence, during the ML setup procedure, they transmit a ML Association request frame for which the EMLSR Support subfield 221 and the EMLMR Support subfield 223 of the EML Capabilities subfield 220 of the Common Info field 210 of the Basic Variant Multi-Link element 200 are both set to 1.

In other scenarios covered by the D1.3 standard, non-AP MLDs 120 and 130 support only one of the EMLSR and EMLMR modes.

Once the candidate links have been setup, capabilities have been exchanged and setup links have been enabled, the non-AP MLDs 120, 130 perform Multi-Link Operation (MLO) with their associated AP MLD 110 over the enabled links. An example of MLO is an exchange of frames (uplink and/or downlink communication).

During MLO, each of the non-AP MLDs may activate the EMLSR or EMLMR mode if appropriate. To activate one of the EML OM, a non-AP MLD sends an EHT Action frame to AP MLD 110, typically an EML Operating Mode Notification frame with its EMLMR Mode subfield or EMLSR Mode subfield equal to 1. The EML OM frame is identified by an EHT Action field (in the octet immediately after the Category field) set to 1.

FIG. 3a illustrates the format of the EML Control field forming the EML OM Notification frame used to activate or deactivate an EML OM as defined in the IEEE P802.11 be/D1.1 standard version (July 2021).

The 8-bit EML Control field 300a of the EML OM frame includes a one-bit EMLSR Mode subfield 311, a one-bit EMLMR subfield 312 and 6 reserved bits 330.

A non-AP MLD supporting EMLSR operations (as declared in its EML capabilities) sets the EMLSR Mode subfield 311 to 1 to request an activation of the EMLSR mode. This indicates that the non-AP MLD is going to operate in EMLSR mode.

The non-AP MLD supporting EMLSR operations (as declared in its EML capabilities) sets the EMLSR Mode subfield 311 to 0 to indicate that it does no longer intend to operate in EMLSR mode.

The EMLSR Mode subfield 311 is set to 0 for all non-AP MLDs that do not support EMLSR operations.

Similarly, a non-AP MLD supporting EMLMR operations (as declared in its EML capabilities) sets the EMLMR Mode subfield 312 to 1 to request an activation of the EMLMR mode. This indicates that the non-AP MLD is going to operate in EMLMR mode.

The non-AP MLD supporting EMLMR operations (as declared in its EML capabilities) sets the EMLMR Mode subfield 312 to 0 to indicate that it does no longer intend to operate in EMLMR mode.

The EMLMR Mode subfield 312 is set to 0 for all non-AP MLDs that do not support EMLMR operations.

A mutually exclusive usage of the EMLMR and EMLSR modes further requires that the EMLSR Mode subfield 311 (respectively EMLMR Mode subfield 312) be set to 0 for all non-AP MLDs that have set the EMLMR (resp. EMLSR Mode subfield 311) Mode subfield 312 to 1.

As described below, an AP MLD sets the EMLSR Mode subfield 311 and EMLMR Mode subfield 312 to the value obtained from a received EML Operating Mode Notification frame.

FIG. 3b illustrates an alternative format of the EML Control field forming an EML OM Notification frame used to activate or deactivate an EML operating mode, now included in the D1.3 standard.

This alternative format adds EMLSR Link Bitmap field 321 to above EMLSR Mode subfield 311 and EMLMR Mode subfield 312. Reserved subfield 330 includes the remaining unused bits.

EMLSR Link Bitmap subfield 321 is typically coded over 8 or 16 bits and indicates a set of enabled links or subset of the enabled links that is used by the non-AP MLD in the EMLSR mode. This set (or subset) is referred to as “EMLSR links”. For example, non-AP MLD A 120 may designate links 151 and 152 (and thus not link 153) for the EMLSR mode.

Bit at position i in the EMLSR Link Bitmap subfield 321 corresponds to the link with the Link ID equal to i. It is set to 1 to indicate that the link is used by the non-AP MLD for the EMLSR mode and is a member of the EMLSR links; otherwise the bit is set to 0.

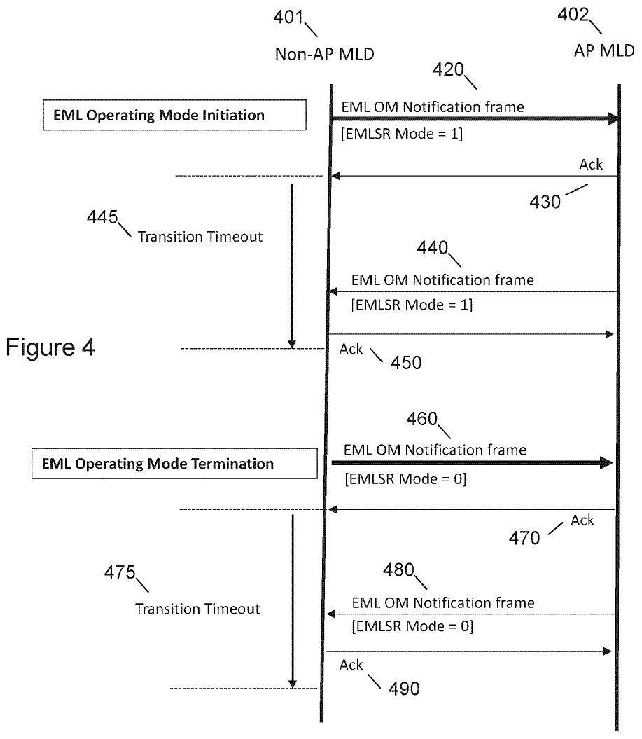

FIG. 4 schematically illustrates an exemplary sequence of frames for activating or deactivating an EML Operating Mode as specified in document IEEE P802.11be/D1.1. The activation of an EML OM by a non-AP MLD is referred to as EML OM Initiation. The deactivation of an EML OM by a non-AP MLD is referred to as EML OM Termination. As shown in the Figure, such activation or deactivation of an EML OM is always initiated by a non-AP MLD.

When a non-AP MLD 401 supporting an EML OM (EMLSR/EMLMR mode) intends to operate in one of the EML OMs, a STA affiliated with the non-AP MLD 401 transmits an EML OM Notification frame 420 (FIG. 3a) to an AP affiliated with AP MLD 402.

The affiliated stations involved in the management frame exchange are referred to as “reporting” affiliated stations, while the other affiliated stations of the same MLDs are referred to as “reported” affiliated stations.

If non-AP MLD 401 intends to activate the EMLSR mode, it sets the EMLSR Mode subfield 311 of the EML Control field 300a of frame 420 to 1. If it intends to activate the EMLMR mode, it sets the EMLMR Mode subfield 312 of the EML Control field 300a of frame 420 to 1. In FIG. 4, EMLSR Mode subfield is set to 1 to seek for an activation of the EMLSR mode.

The AP affiliated with AP MLD 402 that receives the EML OM Notification frame 420 acknowledges the received frame 420 by sending an acknowledgement 430 at MAC level. After successful transmission of the EML OM Notification frame 420 (i.e. after the acknowledgment 430 is sent and received), non-AP STA 401 and AP MLD 402 initialize a Transition Timeout timer 445 with the Transition Timeout subfield value 225 included in the EML Capabilities subfield 220 of the Basic variant Multi-Link element 200 received from the AP MLD during the ML setup procedure.

The Transition Timeout timer 445 starts counting down from the end of the PPDU containing the acknowledgement 430 of the EML OM Notification frame 420. The Transition Timeout defines the maximum time to receive an EML OM Notification frame 440 from the AP MLD before entering the requested OM.

AP MLD 402 may then send an EML OM Notification frame 440 to non-AP STA 401 with an EML Control field set to the same values as EML Control field 300a in the received EML OM Notification frame 420. The transmission of the EML OM Notification frame 440 is made before Transition Timeout timer 445 expires.

The EML OM Notification frame 440 is acknowledged (acknowledgement 450) by non-AP MLD 401.

The EML OM requested by non-AP STA 401 is activated either at the expiration of Transition Timeout timer 445 or after a successful reception of the EML OM Notification frame 440 from AP MLD 420.

Multi-Link Operation (MLO) is performed using the activated EML OM (EMLSR in the example), for example to exchange frames (uplink and/or downlink communication).

When non-AP MLD 401 supporting an EML operating mode (EMLSR/EMLMR) intends to disable the EML mode, a STA affiliated with non-AP MLD 401 transmits an EML OM Notification frame 460 (FIG. 3a) to an AP affiliated with AP MLD 402. If non-AP MLD 401 intends to disable the EMLSR mode, it sets the EMLSR Mode subfield 311 of the EML Control field 300a of frame 460 to 0. If non-AP MLD 401 intends to disable the EMLMR mode, it sets the EMLMR Mode subfield 312 of the EML Control field 300a of frame 460 to 0. In the example of FIG. 4, EMLSR Mode subfield is set to 0 to deactivate the currently active EMLSR mode.

The AP affiliated with the AP MLD 402 that receives the EML OM Notification frame 460 acknowledges the received frame 460 by sending an acknowledgement 470 at MAC level. After successful transmission of the EML OM Notification frame 460 (i.e. after the acknowledgment 470 is sent and received), non-AP STA 401 and the AP MLD 402 initialize a Transition Timeout timer 475 with the Transition Timeout subfield value 225 included in the EML Capabilities subfield 220 of the Basic variant Multi-Link element 200 received from the AP MLD during the ML setup procedure.

The Transition Timeout timer starts counting down from the end of the PPDU containing the acknowledgement 470 of the EML OM Notification frame 460.

AP MLD 402 may send an EML OM Notification frame 480 to non-AP STA 401 with an EML Control field set to the same values as EML Control field 300a in the received EML OM Notification frame 460. The transmission of the EML OM Notification frame 480 is made before Transition Timeout timer 475 expires.

The EML OM Notification frame 480 is acknowledged (acknowledgement 490) by non-AP MLD 401.

The EML OM requested by non-AP STA 401 is disabled either at the expiration of Transition Timeout timer 475 or after a successful reception of the EML OM Notification frame 480 from AP MLD 420.

The same sequence as the one of FIG. 4 can be used with the EML Control field format of FIG. 3b that is now included in the D1.3 standard. In that case, the activation of an EMLSR mode is made using the EMLSR links specified in EMLSR Link Bitmap subfield 321.

This allows the non-AP MLDs to specify various sets of EMLSR links overtime.

Embodiments of the invention seek to allow the MLDs to also use various sets of EMLMR links, referred to as EMLMR links sets. Other embodiments also allow the AP MLD to properly handle the EMLMR links when non-AP MLDs join its BSSs.

For example, a non-AP MLD declares EMLMR capabilities in a ML Association Request, with a set of eligible EMLMR links. Eligible EMLMR links form part or all of the candidate links for set up with an AP MLD. The latter replies with a ML Association Response setting up candidate links and signalling which eligible EMLMR links are accepted. The signalling may involve a Status Code per each link. In operation, the non-AP MLD may then send one or more EML OM Notification frames requesting an activation of an EMLMR mode. Such a frame includes an EML Link bitmap specifying the EMLMR links set to be used. Two EMLMR modes with two separate and disjoint EMLMR links sets can then be activated simultaneously.

In particular, this description proposes a solution for a multi radio non-AP MLD to signal its sets of EMLMR links to an AP MLD. In embodiments, the signaling is performed in two steps:

1. During multi-link setup, a first step signaling is performed in EML Capabilities:
The non-AP MLD signals all the links eligible to any EMLMR mode operation, called eligible EMLMR links. This is done through the subfield called “EMLMR Links Bitmap” which is based on Link IDs.

This first step signaling helps the AP MLD during multi link setup
All the eligible EMLMR Links able to aggregate the Tx/Rx NSS signalled in EML capabilities are identified (based on Link IDs).

Once the multi-link setup is completed, it is not mandatory for the AP MLD to store the content of this subfield (i.e. “EMLMR Links Bitmap”).

2. Once multi-link setup is completed, the second step signaling is performed in EML Control Field carried in the EML notification frame used to activate/deactivate the EMLSR and EMLMR modes:
The EML Control field is as follows:
As the support of EMLSR mode and EMLMR mode is mutually exclusive for a non-AP MLD, the conventional “EMLSR mode” bit and “EMLMR mode” bit are replaced by a single bit called “EML mode”.
Q The conventional “EMLSR Link Bitmap” subfield is renamed “EML Link Bitmap”:
When used by a single radio non-AP MLD, there is no change, the behaviour remains the one described in the D1.3 standard. The only impact is the name of this subfield.
When used by a multi-radio non-AP MLD, this subfield signals (based on Link IDs) a set of EMLMR links (part of all eligible EMLMR links signalled in EML capabilities) involved in the activated/deactivated EMLMR mode. A set of EMLMR links is called an EMLMR links set.

Such embodiments involve the declaration by the non-AP MLDs of the EMLMR links they intend to use for EMLMR mode operations. Such links are referred below to “eligible EMLMR links”.

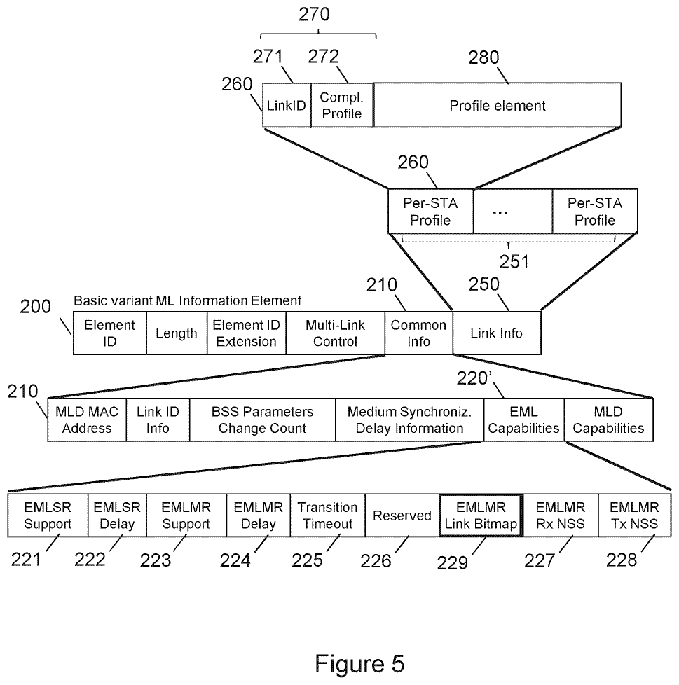

FIG. 5 illustrates such a declaration together with capability information in an enhanced Basic variant Multi-Link Element according to these embodiments. The capability declaration declares support of EML Multi-Radio, MR, operations, and further declares (or signals) a set of eligible EMLMR links in which applying the EMLMR operations.

Given the role of the ML Association Request frame to solicit the setting up of candidate links, the declaration may specify which links from the candidate links are eligible EMLMR links in which applying the EMLMR operations.

In the exemplary illustration of the Figure, enhanced Basic variant Multi-Link Element 200 is similar to the one of FIG. 2 (hence same numeral references correspond to same fields), except that the EML capabilities subfield 220′ is modified to include an additional EMLMR Link Bitmap subfield 229 in some embodiments.

EMLMR Link Bitmap 229, preferably an 8 or 16 bits subfield, indicates the eligible EMLMR links. The eligible EMLMR links are all the links eligible to any EMLMR mode operation.

When the EMLMR Link Bitmap subfield 229 is included in a frame sent by a STA affiliated with a non-AP MLD, the i-th bit in the EMLMR Link Bitmap subfield 229 is set to 1 if a link with Link ID equal to i is a member of the eligible EMLMR links; otherwise it is set to 0. When the EMLMR Support subfield 223 is set to 0, the EMLMR Link Bitmap 229 subfield is reserved.

The EMLMR Link Bitmap subfield 229 is thus a declaration bitmap used to declare all the eligible EMLMR links. During the association procedure, the EMLMR Link Bitmap subfield 229 allows a non-AP MLD to indicate to the AP MLD all the eligible EMLMR links concerned by the maximum receive and transmit Nss (Number of spatial streams specified in EMLMR Rx NSS and EMLMR Tx NSS subfields 227, 228) that may be aggregated on one EMLMR link during a given EMLMR mode operation.

Thanks to the EMLMR Link Bitmap subfield 229, the AP MLD has knowledge of all the eligible EMLMR links (concerned by physical resources aggregation during EMLMR mode operation) solicited by the non-AP MLDs. This knowledge helps the AP MLD to decide whether to accept or reject an association with a requesting non-AP MLD, given its own constraints (e.g. in terms of aggregation) at its own radio resources. The process of using this knowledge is described below.

Once the association procedure is completed, it is not mandatory for the AP MLD to store the content of the EMLMR Link Bitmap subfield 229. As explained below, an activation bitmap for EMLMR links can also be inserted in the EML OM notification frames 420.

In some embodiments, the EMLMR Link Bitmap 229 is always included in the EML capabilities 220′ when the non-AP MLD declares EMLMR capabilities (i.e. the EMLMR Support subfield 223 is set to 1).

In other embodiments, the signaling of the set of eligible EMLMR links may required the EMLMR Link Bitmap 229 in some cases, and no bitmap in other cases. In such embodiments, the presence of the EMLMR Link Bitmap 229 included in the EML capabilities 220′ is optional for a non-AP MLD, when it declares EMLMR capabilities (i.e. the EMLMR Support subfield 223 is set to 1).

In such embodiments, the EMLMR Link Bitmap 229 may be used when the eligible EMLMR links form a subset of the candidate links as defined in the ML Association Request frame (i.e. those candidate links defined through conventional fields for the first candidate link with the affiliated reporting AP and through the Per-STA profiles 260 for the other candidate links with the affiliated reported APs).

In other words, when the optional EMLMR Link Bitmap subfield 229 is included in the ML Association Request frame sent by a STA affiliated with a non-AP MLD, the requested links for EMLMR mode operation are the eligible EMLMR links indicated in the EMLMR Link Bitmap 229.

Also, when the optional EMLMR Link Bitmap subfield 229 is not included in the ML Association Request frame sent by a STA affiliated with a non-AP MLD, the requested links for EMLMR mode operation are all the requested candidate links as defined in the ML Association Request frame. The combination of EMLMR Link bitmap absence with EMLMR Support subfield 223 set to 1 defines such situation. In that case, all the accepted links (i.e. setup links) are also links declared as eligible EMLMR links.

As mentioned above, such declaration of eligible EMLMR links may allow the AP MLD to implement decisional strategies.

However, in some embodiments, the AP MLD may respond using a conventional ML Association Response frame. In that case, when the EMLMR Link Bitmap subfield 229 is included in a frame sent by an AP affiliated with an AP MLD, the EMLMR Links Bitmap subfield is set to all 0s. When the EMLMR Support subfield 223 is set to 0, the EMLMR Link Bitmap 229 subfield is reserved.

On the other hand, preferred embodiments improve the management of the wireless network by letting the AP MLD to assess and to signal explicitly whether the proposed eligible EMLMR links are acceptable or not. For instance, the radio resource capabilities of the AP MLD (of its affiliated STAs) may not meet of the requests or needs from the non-AP MLDs. Some links (affiliated STAs) may not support the aggregation or may support a radio resource aggregation up to a certain point (in terms of Rx or Tx NSS).

In that case, the AP MLD may determine and signal, for each of the eligible EMLMR links, whether it supports or not EMLMR operations.

As an example, the AP MLD may determine and signal, for each eligible EMLMR link, whether the eligible EMLMR link (i.e. the radio of the corresponding affiliated AP) supports a number of Rx or Tx spatial streams specified by the non-AP MLD in the capability declaration (i.e. EMLMR Rx NSS and EMLMR Tx NSS subfields 227, 228).

Some eligible EMLMR links may be accepted, while other may not be. Of course, all the eligible EMLMR links may be accepted or refused.

A response, here “capability response” signaling which of the eligible EMLMR links support or not EMLMR operations as determined can then be sent to the requesting non-AP MLD.

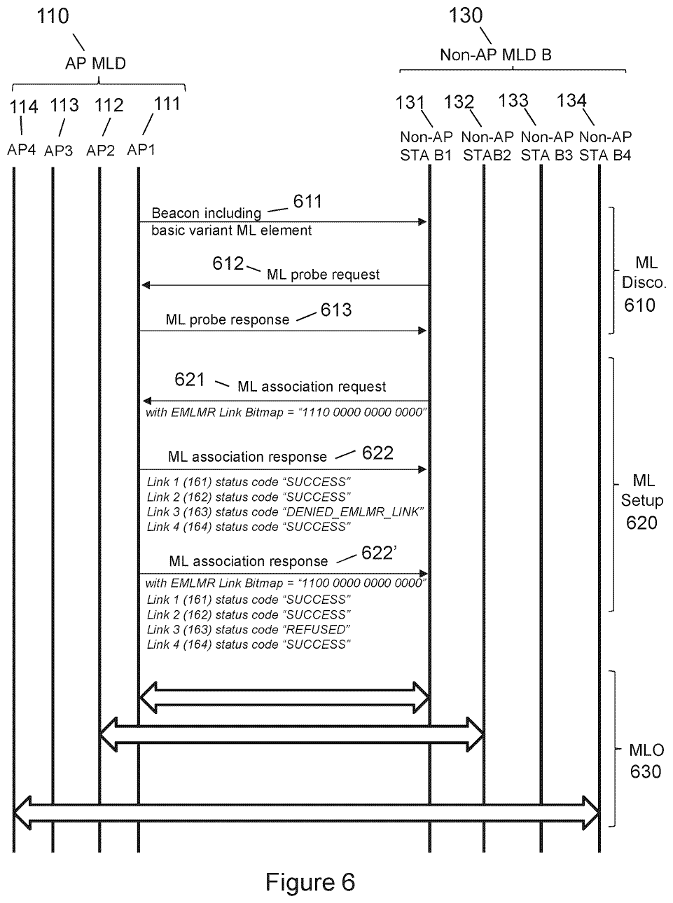

This is now described with reference to FIG. 6 which schematically illustrates an exemplary sequence of management frames between AP MLD 110 and non-AP MLD 120, 130 to perform association while declaring eligible EMLMR links and responding thereof, according to embodiments.

As briefly introduced above, ML beacon frames 611 can be sent by the AP MLD for passive scanning. Also, ML Probe Request and ML Probe Response frames 612, 613 can be exchanged for active scanning to obtain the network information of AP1 as well as the network information of the reported affiliated APs.

In this example, affiliated non-AP station 131 (B1) is the reporting station at non-AP MLD 130 exchanging management frames, while affiliated AP 111 (AP1) is the reporting station at AP MLD 110.

ML Probe Request frame 612 is a Probe Request frame as defined in 802.11 ax (for example IEEE P802.11ax/D8.0 of October 2020) augmented with a Probe Request variant Multi-Link element defined in the D1.3 standard.

In embodiments, upon receiving the ML Probe Request 612, AP MLD 110 shall respond with a ML Probe Response 613 which carries the requested network information for its targeted affiliated APs as indicated in the ML Probe Request 612.

The ML Probe Response 613 is a Probe Response frame as defined in 802.11ax (for example IEEE P802.11ax/D8.0 of October 2020) augmented with a Basic variant Multi-Link element defined in the D1.3 standard. The Basic variant Multi-Link element carries complete or partial per-STA profile(s), based on the soliciting request, for each of the requested AP(s) affiliated with AP MLD 110.

After the ML Discovery procedure 610, non-AP MLD 130 initiates a ML setup procedure 620 to setup links to be involved in the ML transmission to establish, referred to as “setup links”. The ML setup procedure consists in an exchange of ML Association Request 621 and ML Association Response frames 622 or 622′ between the reporting non-AP station (B1 131) affiliated with non-AP MLD 130 and the reporting AP (AP1 111) affiliated with AP MLD 110.

To prepare ML Association Request 621, the reporting affiliated non-AP station B1 determines which candidate (setup) links should be requested to AP MLD 110 (through reporting affiliated AP AP1). This may be done by analysing the network information of the various affiliated APs advertised during the ML Discovery procedure 610.

For example, the reporting affiliated non-AP station B1 may traverse the affiliated AP's Per-STA profiles from high-rank categorized profiles to low-rank categorized profiles. Also, B1 may select affiliated APs operating on separate frequency bands to build candidate setup links on separate frequency bands. The reported affiliated APs for the requested candidate setup links can thus be selected based on the advertised categorization of the profiles, when categorization is provided in the management frames of the ML Discovery procedure.

Any policy to choose which affiliated non-AP station of the non-AP MLD to use with which affiliated AP of the AP MLD can be used to build a requested candidate link. In practice, the affiliated non-AP station and AP of a requested candidate link operate on the same frequency band. For illustrative purposes only, the non-AP MLD may take into account radio constraints of its affiliated non-AP stations.

Once the requested candidate links are known, the non-AP MLD requests AP MLD 110 to setup those links. This is done by sending, by any (reporting) affiliated non-AP station of the non-AP MLD, ML Association Request frame 621 indicating the requested candidate links with affiliated APs of the AP MLD that are requested for ML setup.

First, the legacy (i.e. fields readable by 802.11ax or earlier stations) of the ML Association Request frame are used in a conventional way, to request the association of the reporting affiliated non-AP station (here B1 131) with the addressee reporting affiliated AP (here AP1 111). This defines a first requested candidate link (defined between the reporting affiliated non-AP and AP stations).

Next, Link Info field 250 indicates the other requested candidate links that are requested for setup. Link Info field 250 is made of a set of Per-STA Profile subelements 260, each Per-STA Profile element defining one of the requested candidate links.

A requested candidate link is defined between an affiliated AP of the AP MLD and an affiliated non-AP station of the non-AP MLD. Link ID subfield of the Per-STA Profile is set to the Link ID of the affiliated AP corresponding to the requested candidate link concerned. Complete Profile subfield is set to 1 and Profile Element subfield includes all the network information elements of the affiliated non-AP station corresponding to the requested candidate link concerned.

In the example, four candidate links 161-164 are requested in ML Association Request frame 621: candidate link 161 is defined in the 802.11ax fields while the other candidate links 162-164 are signaled through three corresponding Per-STA Profiles 260.

The non-AP MLD can also declare its capabilities, in particular EMLSR or EMLMR capabilities, using fields 221 or 223 described above.

When the capability declaration signals support for EMLMR operations, it is provided that the capability declaration further declares (or signals) a set of eligible EMLMR links in which applying the EMLMR operations.

As shown in the Figure, three of the four candidate links may be signaled as eligible EMLMR links thanks to EMLMR Link Bitmap subfield 229 set to “1110 0000 000 000”. Here, the first to third links, 161-163, are signalled as eligible EMLMR links.

Of course, if ML Association Request frame 621 were deprived of EMLMR Link Bitmap subfield 229, this would have meant that all the four candidate links were signalled as eligible EMLMR links.

Based on the signaling of the requested candidate links, AP MLD 110 determines which ones are acceptable, and thus define setup links.

In addition, based on the signaling of EMLMR Link Bitmap 229 or the absence thereof (relatively to the requested candidate links), AP MLD 110 checks whether each of the eligible EMLMR links can meet some requirements, in particular with respect to Tx or Rx NSS.

For example, AP MLD 110 checks whether its reporting affiliated AP 111 (defining the first eligible EMLMR link 161) supports at least a number of Rx NSSs as specified in field 227 of the received ML Association Request frame 621 and at least a number of Tx NSSs as specified in field 228 of the same received frame. Then, it checks the same for its reported affiliated AP 112 (defining link 162) and its reported affiliated AP 113 (defining link 163). There is no need to check such requirement for the last link 164 as it is not signalled as eligible EMLMR link.

The results of the checks are saved in memory to prepare a capability response to be sent to the requesting non-AP MLD 130. The capability response may be included in a management frame such as the ML Association Response frame sent in response to ML Association Request frame 621.

ML Association Response frame 622 illustrates a first implementation for the capability response.

ML Association Response frame 622′ illustrates another implementation for the capability response.

Any ML Association Response frame is an Association Response frame as defined in 802.11ax (for example IEEE P802.11ax/D8.0 of October 2020) augmented with a Basic variant Multi-Link element 200 as defined in the D1.3 standard (FIG. 2) or as in FIG. 5.

The 802.11ax fields of the ML Association Response frame 622/622′ are used in a conventional way, to accept the association of the reporting affiliated non-AP station (here B1 131) with the addressee reporting affiliated AP (here AP1 111) on the corresponding Link 1 (161) by indicating the Status code of “SUCCESS” in an appropriate field (usually in the Association Response frame body). A Status Code field is indeed used in a response Management frame to indicate the success or failure of a requested operation in the 802.11 standards. About 6 new status code values (130-135) are already defined in the D1.3 of the 802.11be standard amendment in addition to the 129 status code values defined in the baseline 802.11-2020. The ML Association Response frame 622/622′ provides on this occasion an Association Identifier (AID) to the requesting non-AP MLD 130 for use in the wireless communications with the affiliated APs of AP MLD 110.

The Basic variant ML element 200 of the ML Association Response frame indicates the acceptance or refusal of the association for each reported affiliated non-AP station (here B2 132, B3 133 and B4 134) with the corresponding affiliated AP (here AP2 112, AP3 113 and AP4 114, respectively) on the corresponding link (here Link 2 162; Link 3 163 and Link 4 164, respectively) by indicating the appropriate Status code value (SUCCESS for example) in the corresponding Per-STA Profile subelement 260.

The non-AP MLD can thus know from received ML Association Response frame 622/622′ which candidate links are accepted and thus become setup links. A particular situation arises in case of refusal of link 1 between the reporting non-AP and AP. In that case, all the candidate links are rejected, without a need to check the status code in the Per-STA Profile subelements 260 for the other candidate links. This is because no AID is provided to the non-AP MLD as a consequence of such refusal for the “main” link.

In some embodiments corresponding to ML Association Response frame 622, the capability response signals which of the eligible EMLMR links support or not EMLMR operations by using a status code associated with each of the candidate links. In other words, the above Status Code is used to convey the acceptance or not of the eligible EMLMR links by the AP MLD 110.

Status Code SUCCESS can still be used to signal a candidate link that is both accepted as a setup link and as an eligible EMLMR link.

Another Status Code can be used to signal a candidate link that is refused as an eligible EMLMR link.

For example, a new Status Code labelled “DENIED_EMLMR_LINK” can be defined with value 136 (or any from 136-65535).

Its definition can be as follows: association (for the concerned link) denied because the requested link for EMLMR mode operation is not supported by the AP affiliated with the AP MLD. Such Status Code thus signals that the corresponding candidate link that is both refused as a setup link and as an eligible EMLMR link.

In variant, such a code may be used only to signal a refusal for eligibility to EMLMR operation, but with an acceptance as a setup link (hence without EMLMR capability).

In the Figure, ML Association Response frame 622 signals that links 1 and 2 are accepted as both setup links and eligible EMLMR links and link 4 is accepted as setup link only (because there is no request for it to be eligible EMLMR link): the Status Code is set to SUCCESS in the 802.11 ax fields (for link 1) or in the corresponding Per-STA Profile subelements (for links 2 and 4). An association between the respective reporting/reported non-AP stations and APs is thus obtained.

Similarly, link 3 is refused as setup and eligible EMLMR link: the Status Code is set to DENIED_EMLMR_LINK in the corresponding Per-STA Profile subelement. An association between the respective reported non-AP stations (B3 133) and AP (AP3 113) is thus refused/rejected.

When the EMLMR Link Bitmap subfield 229 is included in ML Association Response frame 622 sent by an AP affiliated with an AP MLD (FIG. 5), the EMLMR Links Bitmap subfield is preferably set to all 0s.

In some embodiments corresponding to ML Association Response frame 622′, the capability response includes a bitmap signaling which links from the set of candidate links support EMLMR operations and which links do not support EMLMR operations.

Conventional values for the Status Codes are used by AP MLD 110 to signal which candidate links (or associations between corresponding non-AP stations and APs) are accepted as setup links (SUCCESS) or rejected (REFUSED).

EMLMR Link Bitmap subfield 229 (FIG. 5) is used to signal which candidate links accepted as setup links (Status Code=SUCCESS) are also accepted as eligible EMLMR links.

For example, the same bit values as received in the ML Association Request frame 621 can be used to indicate that all requested links for EMLMR operation are supported. On the other hand, different bit values from those received in the ML Association Request frame 621 can be used to indicate the requested links for EMLMR operation that are not all supported. The concerned links are identified by a bit value switches from 1 to 0.

In other words, the i-th bit in the EMLMR Link Bitmap subfield 229 is set to 1 if a link with Link ID equal to i is accepted as a member of the eligible EMLMR links; otherwise it is set to 0.

In the example of the Figure, ML Association Response frame 622′ signals that links 1, 2 and 4 are accepted as setup links (Status Code=SUCCESS) and links 1 and 2 are further accepted as eligible EMLMR links (first and second bits of EMLMR Link Bitmap subfield 229 set to 1). On the other hand, link 3 is refused as setup link (Status Code=REFUSED) and as eligible EMLMR link (third bit of EMLMR Link Bitmap subfield 229 set to 0): the requested eligible EMLMR link that is not supported is signalled in the EMLMR Link Bitmap 229 by switching the corresponding bit value from 1 to 0 in comparison with the EMLMR Link Bitmap 229 received in the ML Association Request frame 621 (here the 3^{rd} bit of the bitmap corresponding to the Link 3 163 is switched from 1 to 0).

In some embodiments, when an eligible EMLMR link is refused by the AP MLD, the underlying association is also rejected (Status Code=REFUSED for the same link).

In other embodiments, the acceptance of the candidate link and the acceptance of the eligibility as an EMLMR link can be used independently. It means that, while the bitmap signals which links are eligible EMLMR links, a status code associated with each of the candidate links further indicates whether the candidate link is accepted to set up a link For example, an eligible EMLMR link can be refused by the AP MLD (bit set to 0 in the bitmap) while the underlying association is accepted (Status Code=SUCCESS for the same link).

The ML setup procedure 620 between non-AP MLD 130 and AP MLD 110 terminates with the establishment of three setup links (Link 1 161, Link 2 162 and Link 4 164) among the 4 requested candidate links, with two (Link 1 and Link 2) being declared as eligible to EMLMR operations.

In this situation, non-AP MLD 130 becomes in associated state with AP MLD 110 and is assigned an AID for wireless communication over the multiple links.

Non-AP MLD 130 then configures its affiliated non-AP stations 131, 132 and 134 for ML transmitting/receiving through the established setup links. Assignments of TIDs to the setup links change their states to enabled links.

Next, the Multi-Link Operation (MLO) 630, i.e. exchange of frames, can take place on the enabled links (here Link 1 161, Link 2 162 and Link 4 164).

As briefly mentioned above, the supported EML OMs can selectively be activated or deactivated. The modes are requested by the non-AP MLDs using EML OM notification frames 420.

A non-AP MLD that has declared the support of EMLSR mode through the EML Capabilities field 220, 220′ by setting the EMLSR Support subfield 221 to the value 1, can trigger activation (or deactivation) of an EMLSR mode by setting EMLSR Mode field 311 in the EML Control field 300b forming the EML OM Notification frame 420 (FIG. 3b) to 1. As shown in FIG. 3b, the non-AP MLD activating the EMLSR mode can indicate the links concerned by the selected EMLSR mode, using EMLSR Link Bitmap 321.

A non-AP MLD that has declared the support of EMLMR mode through the EML Capabilities field 220, 220′ by setting the EMLMR Support subfield 223 to the value 1, can trigger activation (or deactivation) of an EMLMR mode by setting EMLMR Mode field 312 in the EML Control field of the EML OM Notification frame 420 to 1.

Given the possibility for non-AP MLDs to define plural eligible EMLMR links, a non-AP MLD may operate in the EMLMR mode on at least one specified set of the enabled links between the non-AP MLD and its associated AP MLD. A specified set of the enabled links in which the EMLMR mode is applied is called an EMLMR links set. In embodiments, an EMLMR links set shall be indicated in the EML Link Bitmap subfield of the EML Control field of the EML Operating Mode Notification frame by setting the bit positions of the EML Link Bitmap to 1.

An EMLMR links set indicated in the EML Link Bitmap subfield is composed of EMLMR links that were part of the eligible EMLMR links indicated in the EMLMR Link Bitmap subfield 229 of the Common Info field of the Basic Multi-Link element.

The EML Link Bitmap subfield to signal the EMLMR links set can of course be an addition bitmap (additional to bitmap 321) in the EML Control field 300b forming the EML OM Notification frame 420.

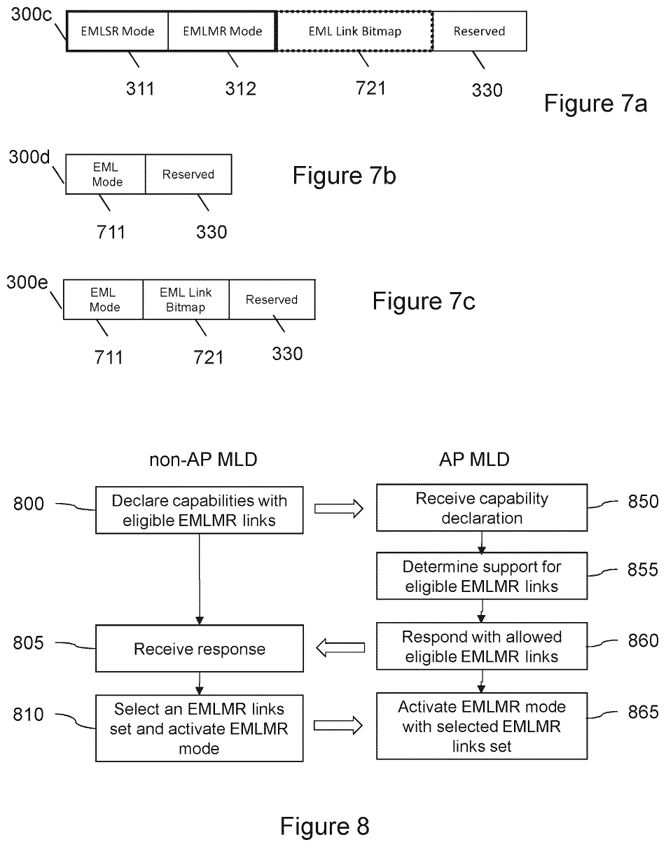

However, when the EMLSR and EMLMR modes are mutually exclusive, the same subfield 321 can be used to indicate which EMLSR links to be used when activating the EMLSR mode (EMLSR Mode subfield 311 set to 1 in frame 420) or which EMLMR links set to be used when activating the EMLMR mode (EMLMR Mode subfield 312 set to 1 in frame 420). Subfield 321 thus operate as EML Link Bitmap subfield 721 as shown in FIG. 7a. The EML Link Bitmap subfield 721 is an activation bitmap used to specify and activate either an EMLSR links set or an EMLMR links set. In other words, the EML Control field includes an EML Link Bitmap subfield signaling a set of links for activating the EMLSR or EMLMR OM.

Embodiments of the invention seeking to reduce signalling costs may use variants to the above EML Control field formats. They are illustrated in FIGS. 7b and 7c.

As shown in these Figures, EMLSR Mode subfield 311 and EMLMR Mode subfield 312 are merged into a single one-bit subfield 711, named EML Mode subfield. The EML Mode subfield is used to implicitly enable or disable either the EMLSR, or the EMLMR mode.

This is made possible thanks to the capability declaration exchanged from non-AP MLD 401 acting as a requesting MLD to AP MLD 402 acting as a requested MLD, declaring that the requesting MLD supports Enhanced Multi-Link, EML, operations: a non-AP MLD indicates which mode it supports in the EML Capabilities field of the Basic Multi-Link element that it transmits.

As mentioned above, the capability declaration is conveyed in an EML Capabilities field 220, 220′ having a first EMLSR Support subfield 221 to declare support of EMLSR operations and a second EMLMR Support subfield 223 to declare support of EMLMR operations. One only of the two subfields may be enabled in which case the single one-bit subfield 711, namely EML Mode subfield, inherits from the declared supported mode (either EMLSR or EMLMR): EML Mode subfield indicates the activation or deactivation of the sole EML OM supported as declared during the association procedure. This applies for instance when the two modes are mutually exclusive, i.e. the requesting non-AP MLD cannot support both the EMLSR Mode and the EMLMR Mode, hence declare only one of the two modes.

EML Control field 300d or 300e of the exchanged EML OM frame 420, 440, 460, 480 requesting an activation or deactivation of an EML OM includes one one-bit EML Mode subfield 711 (FIG. 7b, 7c) and optionally an EML Link Bitmap subfield 721 (FIG. 7c).

A non-AP MLD 401 that supports enhanced multi-link single radio (EMLSR) operation sets the EML Mode subfield 711 to 1 to implicitly indicate an activation of the EMLSR mode and thus that the non-AP MLD 401 operates in EMLSR mode. On the other hand, non-AP MLD 401 sets the EML Mode subfield 711 to 0 to indicate a deactivation of the current EMLSR mode, and thus that the non-AP MLD 401 does not operate in the EMLSR mode.

Similarly, a non-AP MLD 401 that supports enhanced multi-link multi radio (EMLMR) operation sets the EML Mode subfield 711 to 1 to implicitly indicate an activation of the EMLMR mode and thus that the non-AP MLD 401 operates in EMLMR mode. On the other hand, non-AP MLD 401 sets the EML Mode subfield 711 to 0 to indicate a deactivation of the current EMLMR mode, and thus that the non-AP MLD 401 does not operate in the EMLMR mode.

On the other hand, an AP MLD that receives an EML Operating Mode Notification frame from a STA affiliated with a non-AP MLD sets the EML Mode subfield of the EML Operating Mode Notification frame that is sent in response to the value obtained from the received EML Operating Mode Notification frame.

Upon sending or receiving the requesting EML OM Notification frame 420 or 460 or the responding EML OM Notification frame 440 or 480, non-AP MLD 401 and AP MLD 402 activate or deactivate an EML OM depending on the combination of the EML Capabilities field 220 or 220′ and the EML Mode subfield 711. For example, in case the one-bit EML Mode subfield 711 of the requesting EML OM Notification frame 420 is set to a first value (value 1), the MLD activates the EMLSR mode with the other MLD if the capabilities declare non-AP MLD 401 supports EMLSR operations or activates the EMLMR mode with the other MLD if the capabilities declare non-AP MLD 401 supports EMLMR operations.

Similarly, the AP MLD can determine which mode is supported by the non-AP MLD before deactivating a current EML OM in response to a requesting EML OM Notification frame 460 requesting a deactivation using EML Mode subfield 711. However, due to the single mode in the mode support declaration, such a requesting frame may merely request the termination of the sole currently active EML OM. Therefore, it may be considered deactivating a current active EML OM when the one-bit EML Mode subfield field is set to a second value (value 0) different from the first value.

In some embodiments when activating an EMLMR mode, the absence of EML Link Bitmap subfield 721 means that the EMLMR mode applies in all the eligible EMLMR links that are enabled (as declared in the capability declaration and as accepted in the capability response).

FIG. 7c illustrates the case where the requesting EML OM Notification frame, e.g. frame 420, includes an EML Link Bitmap field 721 signaling a set of links for activating the EMLSR or EMLMR OM between the two MLDs.

For instance, the EML Link Bitmap subfield 721 indicates the set or subset of the enabled links (named EMLSR links) that is used by the non-AP MLD 401 in the EMLSR mode.

These are the EMLSR links in which the EMLSR mode to activate will apply. In such a case, the bit at position i of EML Link Bitmap subfield 721 corresponds to the link with the Link ID equal to i and is set to 1 to indicate that the link is used by non-AP MLD 401 for the EMLSR mode and is a member of the EMLSR links; otherwise the bit is set to 0. Similarly, the EML Link Bitmap subfield 721 indicates the set or subset of the enabled links (named EMLMR links set) that is used by non-AP MLD 401 in the EMLMR mode. These are the EMLMR links in which the EMLMR mode to activate will apply. In such a case, the bit at position i of EML Link Bitmap subfield 721 corresponds to the link with the Link ID equal to i and is set to 1 to indicate that the link is used by non-AP MLD 401 for the EMLMR mode and is a member of the EMLMR links set; otherwise the bit is set to 0.

Other embodiments of the invention seeking to reduce signalling costs are directed to a simplification of the EML OM Notification frames 460, 480 when link bitmaps (EMLSR or EML Link Bitmap subfield 321/721) are provided upon activating the EML OMs.

In a scenario, a first requesting EML OM Notification frame 420 requesting an activation of an EML OM (EMLSR mode or EMLMR mode) is exchanged between non-AP MLD 401 acting as a requesting MLD and AP MLD 402 acting as a requested MLD, wherein the first requesting EML OM Notification frame includes an EMLSR or EML Link Bitmap field 321/721 (FIG. 3b or 7a or 7c) signaling a set of links to be used in the EML OM to activate. Data are then exchanged between the two MLDs using the activated EML OM. A second requesting EML OM Notification frame 460 requesting a deactivation of the activated EML OM is next exchanged from non-AP MLD 401 to AP MLD 402. In these specific embodiments, the second requesting EML OM Notification frame 460 is deprived of any link bitmap signaling a set of links, i.e. deprived of an EMLSR or EML Link Bitmap field 321/721.

In other words, when EML Mode subfield 711 is set to 0, i.e. to deactivate an activated EML Mode, or when both EMLSR Mode subfield 311 and EMLMR mode subfield 312 are set to 0, EML Link Bitmap subfield 721 may not be included in the EML Control field. Indeed, for a deactivation of an EML OM, the set of links is useless. Hence, thanks the asymmetry between the successive activation and deactivation requesting frames 420 and 460, signaling bits for the link bitmap can be saved (at the deactivation requesting time).

Similarly, as mentioned above, EML Link Bitmap subfield 721 may not be included in the EML Control field when the EMLMR mode applies in all the enabled links declared as eligible EMLMR links (as declared in the capability declaration and as accepted in the capability response). This applies when EMLMR mode subfield 312 is set to 1 or EML Mode subfield 711 is set to 1 (in case the capabilities declare EMLMR support).

The above shows that, in embodiments, if a non-AP MLD intends to switch EMLMR mode on an EMLMR links set after multi-link setup, then a non-AP STA affiliated with the non-AP MLD shall transmit an EML Operating Mode Notification frame with EML Mode subfield 711 equal to 1 or 0, or in a variant with the EMLMR Mode subfield 312 equal to 1 or 0, to respectively enable or disable EMLMR mode for the EMLMR links set indicated in the EML Link Bitmap subfield 721.

In some embodiments seeking to reduce bit costs, a deactivation of an EMLMR mode may be performed without including the EML Link Bitmap subfield 721 in the frame 460, even if there are multiple possible EMLMR links sets (and thus a need to know which one to deactivate). This is possible if the EML OM Notification frame is sent on a link of the EMLMR links set concerned. In particular, for the deactivation of the EMLMR mode on a set of EMLMR links, the “EML Link Bitmap” is not included in the EML Control field carried in the EML notification frame. In such a case, the non-AP MLD sends the EML notification frame on one of the link belonging to this set.

Similarly, an activation of an EMLMR mode may be performed without including the EML Link Bitmap subfield 721 in the frame 420, should this EMLMR links set to activate be known by the non-AP and AP MLDs, for example a predefined EMLMR links set, the entire set of enabled links declared as eligible EMLMR links or the EMLMR links set last used with the link on which the EML OM Notification frame is sent. In other words, in embodiments, if a non-AP MLD intends to deactivate a current EMLMR mode or activate an EMLMR mode applying in an EMLMR links set after multi-link setup, then a non-AP STA affiliated with the non-AP MLD shall transmit, on a link belonging to the EMLMR link set, an EML Operating Mode Notification frame with EML Mode subfield 711 equal to 0 (to deactivate) or 1 (to activate), or in a variant with the EMLMR Mode subfield 312 equal to 0 or 1, to disable or enable the EMLMR mode for this EMLMR links set.

Thanks to EMLMR Link Bitmap 229 (or equivalent signalling) in the EML capabilities subfield 220′ of an ML Association Request frame and to EML Link Bitmap subfield 721 in the EML Control field 300 of the EML OM Notification frames, the non-AP MLDs can first declare their eligible EMLMR links and then select any set or subset of such eligible EMLMR links to be used for any EMLMR mode to activate. This provides a high level of flexibility in the management of the EMLMR modes at the MLD levels.

FIG. 8 summarizes, using flowcharts, such operations at the MLDs.

On the left side, a non-AP MLD performs an association procedure with an AP MLD during which the non-AP MLD declares, at step 800, its capabilities, including all the eligible EMLMR links to the AP MLD. This is done using EMLMR Link Bitmap subfield 229 included the EML capabilities field 220′ of the ML Association Request frame (or in a variant without any bitmap if all the candidate links are eligible EMLMR links). The EMLMR Link Bitmap subfield 229 is thus a declaration bitmap used to declare all the eligible EMLMR links.

On the right side of the Figure, the AP MLD receives, at step 850, such capability declaration with the eligible EMLMR links. At step 855, each eligible EMLMR link is checked to determine whether it supports the solicited EMLMR mode. For instance, this may merely consist in checking whether the corresponding affiliated AP can support a number of spatial stream equal to the Rx NSS and Tx NSS values specified in the capability declaration.

A response thereof (capability response) is built and sent back to the requesting non-AP MLD at step 860. A Status Code per candidate link may be used to indicate whether its eligibility for EMLMR mode is accepted or refused. In a variant, an EMLMR Link Bitmap subfield 229 can be used in the ML Association Response frame.

Such frame is received at step 805 by the non-AP MLD which thus have knowledge of which links are setup (accepted by the AP MLD) and which of them are eligible EMLMR links.

Next, during multi-link operation, the non-AP MLD can decide switching an EML operating mode at step 810 by sending an EML OM Notification frame to the AP MLD.

Such EML OM Notification frame activates an EMLMR mode by specifying, using EML Link Bitmap field 721, an EMLMR links set, i.e. the set of EMLMR links in which the EMLMR mode applies.

The frame is received by the AP MLD at step 865.

A conventional processing of the frame can be performed, taking into account the specific EMLMR links set. Both non-AP MLD and AP MLD then apply the EMLMR mode using radio resource aggregation for the specified EMLMR links set.

In embodiments, when a non-AP MLD operates in the EMLMR mode, after initial frame exchange subject to its per-link spatial stream capabilities and operating mode on one of the links of the EMLMR links set, the non-AP MLD shall be able to support the following until the end of the frame exchange sequence initiated by the initial frame exchange:
Receive PPDUs with the number of spatial streams up to the value as indicated in the EMLMR Rx NSS subfield of the Common Info field of transmitted Basic Multi-Link element at a time on the link for which the initial frame exchange was made.
Transmit PPDUs with the number of spatial streams up to the value as indicated in the EMLMR Tx NSS subfield of the Common Info field of transmitted Basic Multi-Link element at a time on the link for which the initial frame exchange was made.

As multiple and separate EMLMR links set can be defined within the set of enabled links declared as eligible EMLMR links, a non-AP MLD may enable/disable EMLMR mode independently and simultaneously on several EMLMR links sets by transmitting several EML Operating Mode Notification frames to the AP MLD, each having a different EML Link Bitmap 721 signaling the respective EMLMR links set. Indeed, to enable/disable EMLMR mode independently and simultaneously on several EMLMR links sets, the EML Link Bitmap 721 of these sets shall be disjoint in embodiments.

The multiple EML OM Notification frames activating EMLMR modes on separate (disjoint) EMLMR links sets can be sent simultaneously or not, over the same link or not. What is important is that the second EML OM Notification frame is sent while the first EMLMR mode (with a first EMLMR links set) is active. The first EMLMR mode applying in the first EMLMR links set is thus active at the same time as another EMLMR mode applying in a separate EMLMR links set between the same MLDs.

Of course, EMLSR mode can still be activated/deactivated using the same frames and the same fields, provided that EMLSR support be declared in the EML Capabilities. In particular, the EML Link Bitmap field 721 is used to signal the links in which the EMLSR mode applies.

Hence, as an example, when a non-AP MLD enables three links and the first link has Link ID equal to 0, the second link has Link ID equal to 1, and the third link has Link ID equal to 2, and the two links with Link ID equal to 1 and Link ID equal to 2 are used for the EMLSR or EMLMR operation, the two bit positions, the second bit and the third bit positions, of the EML Link Bitmap subfield are set to 1 and other bit positions are set to 0.

In the current version of the IEEE P802.11be/D1.1, the process of activating or deactivating an EML OM is initiated/triggered by non-AP MLD 401. AP MLD 402 only replies with a responding EML OM Notification frame 440, 480 which is similar to the requesting EML OM Notification frame 420, 460. In other words, AP MLD 402 can only accept what non-AP MLD 401 requests. Although the decision by non-AP MLD 401 is probably optimum given non-AP MLD's constraints and knowledge of the network, this is not a satisfactory situation because the AP MLD may also have other constraints or knowledge of the network that could require another decision regarding the EML OMs. An AP MLD may for instance be aware of a quantity of data to be sent in downlink intended to non-AP stations, of current interferences in the BSS or of NSTR constraints for a specific AP such as soft-AP.

The inventors thus have contemplated providing more options for the AP MLD to contribute to the EML OM management (activation, deactivation, and even modification).

Taking advantage of the responding EML OM Notification frames 440, 480, embodiments provide to the AP MLD the ability to refuse a requested activation or deactivation of an EML OM. This means for the AP MLD, responsive to receiving, from a non-AP MLD, a requesting EML OM Notification frame 420, 460 requesting an activation or deactivation of an EML OM, the ability to send, to the non-AP MLD, a responding EML OM Notification frame refusing the activation or deactivation.

In embodiments, the signalling of the refusing may merely rely on using the opposite value in the EML/EMLSR/EMLMR Mode subfield 711/311/312 (depending on the format used) as the value indicated in the requesting EML OM Notification frame.

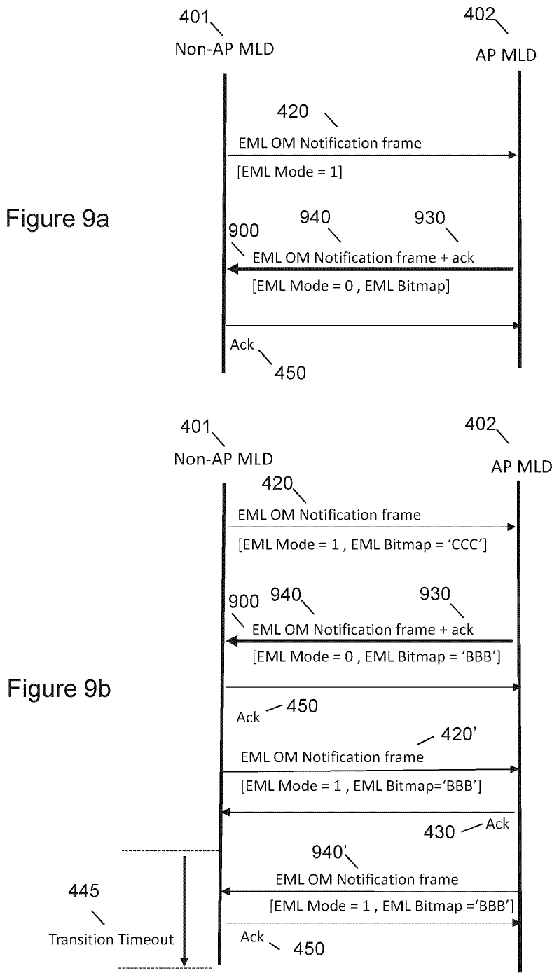

FIG. 9a schematically illustrates such embodiments in an exemplary sequence of frames for activating an EML OM. Of course, a similar approach may be used when refusing a deactivation of an EML OM.

First, non-AP MLD 401 supporting EML operations (either EMLSR or EMLMR or both) sends, to AP MLD 402, a requesting EML OM Notification frame 420 requesting an activation of an EML OM. This is a step similar as described above, based for example of the EML Control field format of FIG. 3a or 7b, meaning that EML Mode subfield 711 or EMLSR Mode subfield 311 or EMLMR Mode subfield 312 is set to 1 for activating an EML OM, or these subfields are set to 0 for deactivating a current EML OM.

In response to receiving such frame, AP MLD 402 determines whether the solicited request (activation in the example, but applicable to deactivation) is acceptable from its own point of view. The deciding process at the AP MLD is not a key aspect of the present embodiments. Hence, any approach to take a decision can be considered. If the solicited request is acceptable, conventional process (see FIG. 4) can be conducted.

On the other hand, in case AP MLD 402 does not agree with the request, it can refuse it by preparing and sending a refusing EML OM Notification frame 940 using the same EML Control field format. EML OM Notification frame 940 from AP MLD 402 is a “refusing” frame because it includes an EML Mode subfield 711/311/312 set to an opposite value (e.g. 0) for the requested EML OM as the corresponding EML Mode subfield in the requesting EML OM Notification frame 620.

Thanks to this opposite value, non-AP MLD 401 receiving, from AP MLD 402, the responding EML OM Notification frame 940 is early aware of the refusal from AP MLD 402.

As shown in the Figure, the responding EML OM Notification frame 940 is preferably included in the same Physical Protocol Data Unit, PPDU 900, as the (MAC) acknowledgment 930 to the requesting EML OM Notification frame 420. Indeed, by early determining the AP MLD's refusal, non-AP MLD 401 can prevent its Transition Timeout timer 445, 475 to be started and thus avoid an automatic activation of the requested EML OM although a refusal thereof is pending. Non-AP MLD 401 and AP MLD 402 therefore not start their local Transition Timeout timer upon sending (for AP MLD) or receiving (for non-AP MLD) an acknowledgment 930 to the requesting EML OM Notification frame 420 that is included in the same Physical Protocol Data Unit, PPDU 900, as the responding EML OM Notification frame 940 refusing the activation. This action interrupts the on-going EML OM initiation.

Non-AP 401 can next send an acknowledgment 450 to frame 940 refusing the activation.

FIG. 9b illustrates a variant wherein a link bitmap is provided in the EML OM Notification frames, still applicable to deactivations although it is described below with respect to a request to activate an EML OM. Any EML Control field format 300b (FIG. 3b), 300c (FIG. 7a), 300e (FIG. 7c) can be used.

First, non-AP MLD 401 supporting EML operations (either EMLSR or EMLMR or both) still sends, to AP MLD 402, a requesting EML OM Notification frame 420 requesting an activation of an EML OM, such frame 420 including a link bitmap 321/721 indicating links to be used for the EML OM to activate. In this example, link bitmap “CCC” is specified. In the case of EMLMR mode activation, “CCC” designates an EMLMR links set (preferably selected from the eligible and enabled EMLMR links).

In response to receiving such frame, AP MLD 402 determines whether the solicited request (activation in the example, but applicable to deactivation) is acceptable from its own point of view. The deciding process at the AP MLD is not a key aspect of the present embodiments. Hence, any approach to take a decision can be considered. In particular, a decision may be taken with respect to the action of activating an EML OM and/or with respect to the set of links that is signaled in link bitmap “CCC” for the activation.

If the solicited request is acceptable, conventional process (see FIG. 4) can be conducted.

On the other hand, in case AP MLD 402 does not agree with the request, it can refuse it by preparing and sending a refusing EML OM Notification frame 940 using the same EML Control field format. EML OM Notification frame 940 from AP MLD 402 is a “refusing” frame because it includes an EML Mode subfield 711/311/312 set to an opposite value (e.g. 0) for the requested EML OM as the corresponding EML Mode subfield in the requesting EML OM Notification frame 420.

Thanks to this opposite value, non-AP MLD 401 receiving, from AP MLD 402, the responding EML OM Notification frame 940 is early aware of the refusal from AP MLD 402.

In addition, should the decision of the AP MLD to refuse be based on the fact the links proposed in the link bitmap “CCC” are not considered as being the appropriate ones, AP MLD 402 may make a counter-proposal for the set of links. In this respect, it includes, in the responding EML OM Notification frame 640, a Link Bitmap field 321/721 signaling a proposed set of links for activating the EML OM between the two MLDs. The proposed links may be links for which the AP MLD is ready to accept an activation of the EML OM. Any methodology to determine such “acceptable” set of links may be envisioned. In the example of the Figure, the proposed set of alternative links is indicated as link bitmap “BBB” that is indeed different from the first set of links “CCC” signaled in the requesting EML OM Notification 420. In the case of EMLMR mode activation, “BBB” designates an EMLMR links set that is alternative to EMLMR links set “CCC”.

As above, the responding EML OM Notification frame 940 is preferably included in the same Physical Protocol Data Unit, PPDU 900, as the (MAC) acknowledgment 930 to the requesting EML OM Notification frame 420. This is still to prevent the MLD's Transition Timeout timers 445, 475 to be started and thus to avoid an automatic activation of the requested EML OM although a refusal thereof is pending.

Non-AP MLD 401 can next send an acknowledgment 450 to frame 940 refusing the activation.

Being aware of the set of links “BBB” AP MLD 402 is ready to accept, non-AP MLD 401 can decide to send, to AP MLD 402, a new requesting EML OM Notification frame 420′ requesting an activation of an EML OM, such frame 420′ including, this time, the proposed set of links “BBB”.

As this request will be accepted by AP MLD 402, the subsequent steps are conventional steps with an acknowledgment 430 starting the Transition Timeout timer 445, an EML OM Notification frame 940′ identical to the requesting EML OM Notification frame 420′ and a final acknowledgment 450.

This embodiment of FIG. 9b shows a first illustrative level of the AP MLD's ability to make proposals or suggestions to non-AP MLDs for the EML OM management.

Embodiments of the invention also provide the AP MLD with abilities to suggest, to the non-AP MLDs, activations and deactivations of EML OMs in line with the EML capabilities of those non-AP MLDs as declared during the ML setup procedure. Such suggestions sharply contrast with the D1.3 standard where only the non-AP MLDs initiate the EML OM activation/deactivation procedure.

These embodiments rely on an EML OM Notification frame, sent by the AP MLD to a non-AP MLD, defining (i.e. including or notifying or signaling) a proposal from the AP MLD to activate or deactivate or modify an EML OM. As this frame is a mere suggestion or proposal to take an EML OM management action, it is spontaneously sent by the AP MLD at its own initiative. By spontaneous, it is meant without any prompt from the non-AP MLD: the non-AP MLD thus receives, from the AP MLD, a—spontaneous—EML OM Notification frame defining a proposal from the AP MLD to activate or deactivate or modify an EML OM. For instance, this EML OM Notification frame precedes a requesting EML OM Notifications frame 420 from the non-AP MLD.

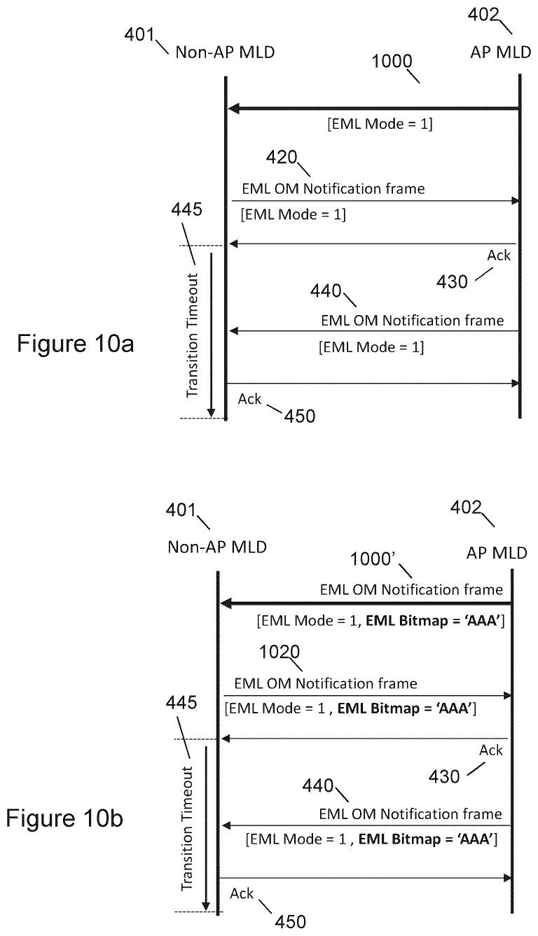

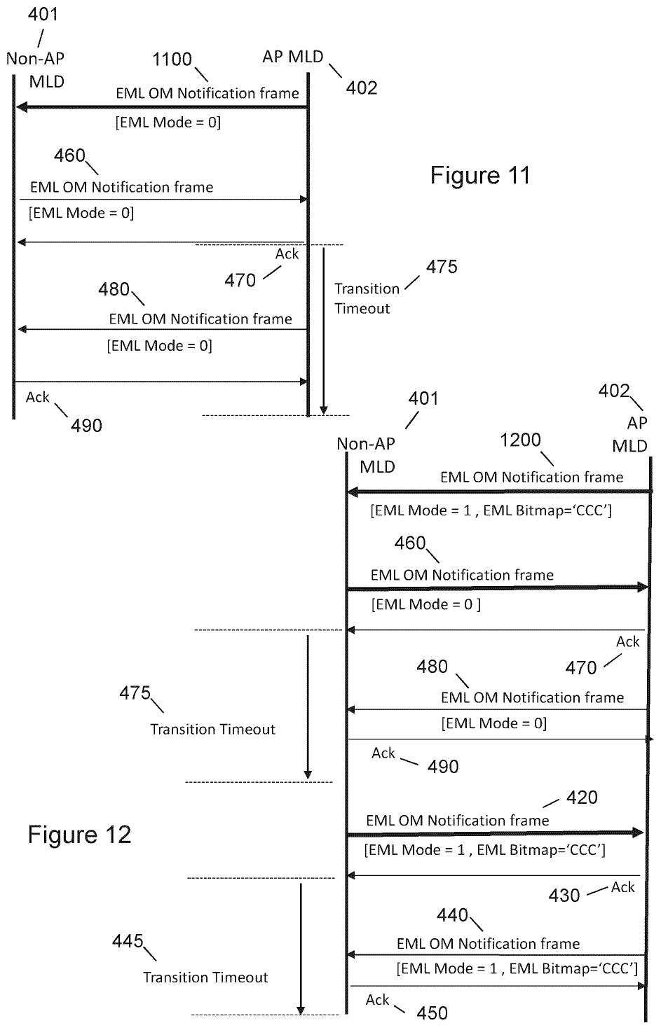

These embodiments are illustrated by FIGS. 10a and 10b with respect to the activation of an EML OM, by FIG. 11 with respect to the deactivation of a currently active EML OM, and by FIG. 12 with respect to the modification of a currently active EML OM.

The AP MLD is aware of which non-AP MLD supports EML operations, in particular the EMLSR mode and/or the EMLMR mode, thanks to the EML Capabilities exchanged during the association of the non-AP MLD to the AP MLD.

As shown in FIG. 10a, an EML OM Initiation Proposal from the AP MLD includes the sending, by AP MLD 402 to a non-AP MLD (e.g. non-AP MLD 401), of EML OM Notification frame 1000 proposing to activate an EML OM. Any of the EML Control field formats of FIGS. 3a and 7b can be used. As being a proposal for an EML OM activation, EML OM Notification frame 1000 has its EML Mode subfield 711 or EMLSR Mode subfield 311 or EMLMR Mode subfield 312 set to 1 for activating an EML OM which is supported by the targeted non-AP MLD.

The sending may be responsive to a triggering event detected locally, for example a change in network conditions that leads the AP MLD to suggest the EMLSR and/or EMLMR modes with some or all of its associated non-AP MLDs. The triggering event excludes the reception of an EML OM Notification frame requesting the same activation, from the non-AP MLD.

Because EML OM Notification frame 1000 is received by non-AP MLD 401 without prior sending of an EML OM Notification frame, it is considered by non-AP MLD 401 as being a suggestion or proposal from AP MLD 402. Therefore, non-AP MLD 401 can evaluate the opportunity to follow the AP MLD 402's suggestion/proposal and hence to request an activation of an EML OM as suggested (for example to activate the EMLSR mode if AP MLD 402 suggests activating such mode).

Once non-AP MLD 401 evaluates positively the opportunity, it sends, in response to the received (suggesting) frame 1000, to AP MLD 402, a requesting EML OM Notification frame 420 requesting an activation of the EML OM, then starting any procedure processing such frame 420 (e.g. the conventional process of FIG. 4 or a process with a refusal as in FIG. 9a or 9b). In the example of the Figure, the subsequent steps are conventional steps with an acknowledgment 430 starting the Transition Timeout timer 445 (triggering an actual activation of the requested EML OM), an EML OM Notification frame 440 identical to the requesting EML OM Notification frame 420 (in particular the same EML Mode subfield 311/312/711) and a final acknowledgment 450.

FIG. 10b illustrates a variant wherein a link bitmap is provided in the EML OM Notification frame 1000′ to suggest a set of links to be used for the EML OM to activate. Any EML Control field format 300b (FIG. 3b), 300c (FIG. 7a), 300e (FIG. 7c) can be used.

Again, the EML OM Initiation Proposal from the AP MLD includes the sending, by AP MLD 402 to non-AP MLD 401, of EML OM Notification frame 1000′ proposing to activate an EML OM. As being a proposal for an EML OM activation, EML OM Notification frame 1000′ has its EML Mode subfield 711 or EMLSR Mode subfield 311 or EMLMR Mode subfield 312 set to 1 for activating an EML OM which is supported by the targeted non-AP MLD. In addition, EML OM Notification frame 1000′ includes an EMLSR/EML Link Bitmap field 321/721, signaling a proposed set of links for activating the EML OM between the two MLDs. In this example, link bitmap “AAA” corresponding to the proposed set of links is signaled in subfield 321/721. In the case of proposed EMLMR mode, “AAA” designates a proposed EMLMR links set (preferably selected from the eligible and enabled EMLMR links).

The sending may be responsive to a triggering event as described above.

If non-AP MLD 401 evaluates positively the opportunity to activate an EML OM as suggested by AP MLD 402, it sends, in response to the received (suggesting) frame 1000′, to AP MLD 402, a requesting EML OM Notification frame 1020 requesting an activation of the EML OM, then starting any procedure processing such frame 420 (e.g. the conventional process of FIG. 4 or a process with a refusal as in FIG. 9a or 9b). The requesting EML OM Notification frame 1020 also includes a link bitmap 321/721.

In some embodiments where non-AP MLD 401 follows the AP MLD's suggestion, link bitmap 321/721 of frame 1020 corresponds to the same proposed set of links as frame 1000′. This is the case in FIG. 10b where frame 1020 also signals link bitmap “AAA”.

In some embodiments (not shown in the Figure) where non-AP MLD 401 estimates that another set of links should be used for the EML OM activation, link bitmap 321/721 of frame 1020 corresponds to a set of links (e.g. “BBB”) different from the proposed set of links (“AAA”) as defined in frame 1000′. In the case of EMLMR mode activation, “BBB” thus designates an EMLMR links set that is alternative to proposed EMLMR links set “AAA”.

In the example of the Figure, the subsequent steps are conventional steps with an acknowledgment 430 starting the Transition Timeout timer 445 (triggering an actual activation of the requested EML OM), an EML OM Notification frame 440 identical to the requesting EML OM Notification frame 420 (in particular the same EML Mode subfield 311/312/711) and a final acknowledgment 450.

Turning now, as shown in FIG. 11, to an EML OM Termination Proposal from the AP MLD, it includes the sending, by AP MLD 402 to non-AP MLD 401, of EML OM Notification frame 1100 proposing to deactivate a currently active EML OM. Any of the EML Control field formats of FIGS. 3a and 7b can be used. As being a proposal for an EML OM deactivation, EML OM Notification frame 1100 has its EML Mode subfield 711 or its EMLSR Mode subfield 311 and EMLMR Mode subfield 312 set to 0 for deactivating a currently active EML OM.

The sending may be responsive to a triggering event detected locally, for example a change in network conditions that leads the AP MLD to suggest terminating the active EMLSR and/or EMLMR modes with some or all of its associated non-AP MLDs. The triggering event excludes the reception of an EML OM Notification frame requesting the same deactivation, from the non-AP MLD.

Because EML OM Notification frame 1100 is received by non-AP MLD 401 without prior sending of an EML OM Notification frame, it is considered by non-AP MLD 401 as being a suggestion or proposal from AP MLD 402. Therefore, non-AP MLD 401 can evaluate the opportunity to follow the AP MLD 402's suggestion/proposal and hence to request a deactivation of a currently active EML OM as suggested by AP MLD 402 (for example to deactivate a currently active EMLSR mode if AP MLD 402 suggests deactivating such mode).

Once non-AP MLD 401 evaluates positively the opportunity, it sends, in response to the received (suggesting) frame 1100, to AP MLD 402, a requesting EML OM Notification frame 460 requesting a deactivation of the EML OM, then starting any procedure processing such frame 460 (e.g. the conventional process of FIG. 4 or a process with a refusal as in FIG. 9a or 9b). In the example of the Figure, the subsequent steps are conventional steps with an acknowledgment 470 starting the Transition Timeout timer 475 (triggering an actual deactivation of the requested EML OM), an EML OM Notification frame 480 identical to the requesting EML OM Notification frame 460 (in particular the same EML Mode subfield 311/312/711) and a final acknowledgment 490.

Turning now, as shown in FIG. 12, to an EML OM Modification Proposal from the AP MLD, it seeks to modify an EML OM currently active with a given set of links into the same EML OM (i.e. EMLSR or EMLMR) with however another set of links. The process includes the sending, by AP MLD 402 to non-AP MLD 401, of EML OM Notification frame 1200 proposing to modify a currently active EML OM. Any of the EML Control field formats of FIGS. 3b, 7a and 7c can be used. Indeed, a proposed modification induces proposing a new set of links compared to those links already used by the currently active mode.

For example, an EMLMR mode may be currently active in EMLMR links set “BBB” whereas AP MLD 402 wishes to move the EMLMR mode in another EMLMR links set, namely “CCC” (preferably selected from the eligible and enabled EMLMR links).

As the current signalling in the EML OM Notification frames does not directly allow signalling a modification of an EML OM, the modification process may be a two-step process with a deactivation of a currently active EML OM followed by an activation of the same EML OM with another set of links. In other words, in response to the received EML OM Notification frame 1200, non-AP MLD 401 sends a first requesting EML OM Notification frame 460 requesting a deactivation of the currently active EML OM (identified in frame 1200) and then sends a second requesting EML OM Notification frame 420 requesting an activation of the same EML OM with a set of links different from links of the currently active EML OM. The “same” EML OM means an EMLMR mode if the currently active EML OM that has been deactivated was EMLMR, or means an EMLSR mode if the currently active EML OM that has been deactivated was EMLSR. Preferably, to take into account the proposition of links from AP MLD 402, the different set of links in the second EML OM Notification frame 420 is the set of links proposed by AP MLD 402 in frame 1200.

In the example of the Figure, AP MLD 402 suggests a set of links corresponding to link bitmap “CCC”. Hence, EML OM Notification frame 1200 includes an EML Link Bitmap subfield 721 set to “CCC”, while the set of links of the currently active EML OM is “BBB”.

In response to frame 1200, if non-AP MLD 401 evaluates the AP MLD's suggestion as being relevant, it sends, to AP MLD 402, requesting EML OM Notification frame 460 requesting a deactivation of the currently active EML OM, then starting any procedure processing such frame 460 (e.g. the conventional process of FIG. 4). In the example of the Figure, the subsequent steps are conventional steps with an acknowledgment 470 starting the Transition Timeout timer 475 (triggering an actual deactivation of the requested EML OM), an EML OM Notification frame 480 identical to the requesting EML OM Notification frame 460 (in particular the same EML Mode subfield 311/312/711) and a final acknowledgment 490.

Next, it sends, to AP MLD 402, a requesting EML OM Notification frame 420 requesting an activation of the same EML OM with however the proposed set of claims “CCC”, then starting any procedure processing such frame 420 (e.g. the conventional process of FIG. 4 or a process with a refusal as in FIG. 9a or 9b). The requesting EML OM Notification frame 420 includes a link bitmap 321/721 set to the proposed bitmap “CCC”.

In the example of the Figure, the subsequent steps are conventional steps with an acknowledgment 430 starting the Transition Timeout timer 445 (triggering an actual activation of the requested EML OM), an EML OM Notification frame 440 identical to the requesting EML OM Notification frame 420 (in particular the same EML Mode subfield 311/312/711 and same link bitmap) and a final acknowledgment 450.

In a variant not shown, non-AP MLD 401 may send, in response to frame 1200, an EML OM Notification frame 1200′ that includes a “modification” signaling (e.g. a particular flag), with the proposed set of links “CCC”. This is to avoid the two steps of the above two-step approach.

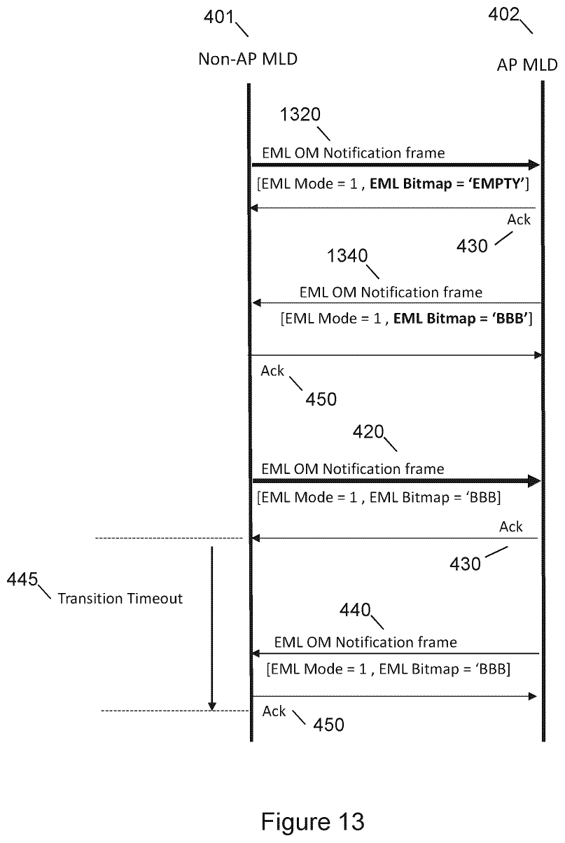

Another way for the AP MLD to provide suggestions or proposals to the non-AP MLD is now described with reference to FIG. 13. In the scenario, non-AP MLD still initiates the activation of an EML OM but either asks the AP MLD for a set of links to be used or provides a set of links that does not satisfy the AP MLD.

In this scenario, the AP MLD thus reacts to a requesting frame from the non-AP MLD: responsive to receiving, from the non-AP MLD, a first requesting EML OM Notification frame requesting an activation of an EML OM, the AP MLD sends, to the non-AP MLD, a responding EML OM Notification frame signaling a proposed set of links for activating the EML OM.

For example, the non-AP MLD may desire activating an EMLMR mode and solicits the AP MLD to know which EMLMR links set (preferably selected from the eligible and enabled EMLMR links) to use. The AP MLD determines the EMLMR links set “BBB” it wishes to use, and then communicates it to the non-AP MLD.

As shown in the Figure, non-AP MLD 401 sends, to AP MLD 402, a first requesting EML OM Notification frame 1320 requesting an activation of an EML OM. Any of the EML Control field formats of FIGS. 3b, 7a and 7c can be used, i.e. frame 1320 includes an EML Link Bitmap subfield 721.

In some embodiments (as the one shown in the Figure), the EML Link Bitmap subfield 721 of frame 1320 is empty or has a predefined bit pattern (all bits to 0, or bit corresponding to a not-existing enabled link set to 1). This is an invitation for AP MLD 402 to indicate (in response) which links to be used for the requested EML OM.

In other embodiments (not shown), the EML Link Bitmap subfield 721 of frame 1320 may be set to a given set of links (i.e. some enabled links are signaled).

A conventional acknowledgment 430 is sent by AP MLD 402. To avoid activating the EML OM with an empty set of links, the MLDs do not start their local Transition Timeout timer 445 based on acknowledgment 430, as an exception to the conventional approach. This mechanism may be based on the link bitmap in frame 1320: the MLD does not start its local Transition Timeout timer upon sending/receiving an acknowledgment to a requesting EML OM Notification frame 1320 when the latter includes an EML Link Bitmap field 721 to signal links that is empty.

Next, AP MLD 402 sends, to non-AP MLD 401, responding EML OM Notification frame 1340 which sets its EML Mode subfield 311/312/711 to the same activation value (here 1) as requesting frame 1320 and signals a set of links AP MLD 402 proposes for activating the requested EML OM. In the example, the set of links corresponding to link bitmap “BBB” is proposed. A conventional acknowledgment 450 is sent by non-AP 402. The proposed set of links is different from the set of links optionally specified in frame 1320.

Non-AP MLD 401 may next evaluate the opportunity to activate an EML OM using the set of links as suggested by AP MLD 402. In the negative, nothing more happens. In the affirmative, it sends, in response to receiving the responding EML OM Notification frame 1340, a second requesting EML OM Notification frame 420 requesting the activation of the EML OM using the proposed set of links “BBB”. The procedure that follows to process such frame 420 may be the conventional process of FIG. 4 (or alternatively a process with a refusal as in FIG. 9a or 9b): an acknowledgment 430 starting the Transition Timeout timer 445 (triggering an actual activation of the requested EML OM) is followed by an EML OM Notification frame 440 identical to the requesting EML OM Notification frame 420 (in particular the same EML Mode subfield 311/312/711) and a final acknowledgment 450.

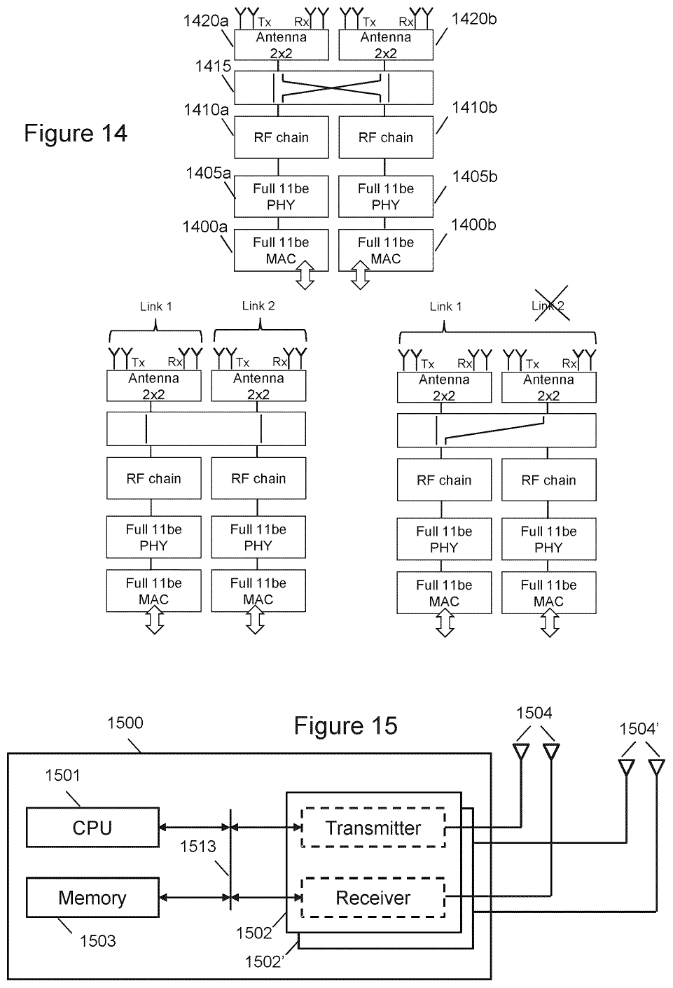

FIG. 14 schematically illustrates an EMLMR capable architecture for an MLD. This Figure takes the example of two affiliated non-AP STAs sharing their antenna resources when the EMLMR mode is activated.

The architecture comprises two radio stacks, one for each non-AP STA.

A radio stack comprises a full 802.11 be MAC module 1400a or 1400b (exchanging data with higher layers), a full 802.11be PHY module 1405a or 1405b connected with the MAC module, a radio-frequency chain 1410a or 1410b connected with the PHY module, an EMLMR switch 1415 shared by the two radio stacks and configured to perform the aggregation of the antenna resources when the EMLMR mode is activated, and an antenna array 1420a or 1420b.

The diagram on the bottom left illustrates the functioning when the EMLMR mode is disabled: the common EMLMR switch 1415 connects each antenna array to its RF chain. Hence, each radio stack is complete and can serve a respective link using for example a 2×2 MIMO antenna configuration. As shown in the Figure, two links are available.

The diagram on the bottom right illustrates the functioning when the EMLMR mode is activated: the common EMLMR switch 1415 aggregates the antenna resource to the first link. To do so, it connects the antenna array 1420b of the second radio stack to the RF chain 1410a of the first radio stack. Hence, the first radio stack can operate in a 4×4 MIMO antenna configuration to improve the throughput of link 1. On the other hand, link 2 can no longer be used as its antenna array 1420b is no longer available for the second radio stack.

Although the illustrative aggregation of the antenna resources deprives the second radio stack of all its antenna resources in the EMLMR mode, it may be contemplated that the EMLMR mode only aggregate a part of these antenna resources to the first radio stack.

FIG. 15 schematically illustrates a communication device 1500, typically any of the MLDs discussed above, of a wireless network, configured to implement at least one embodiment of the present invention. The communication device 1500 may preferably be a device such as a micro-computer, a workstation or a light portable device. The communication device 1500 comprises a communication bus 1513 to which there are preferably connected:
a central processing unit 1501, such as a processor, denoted CPU;
a memory 1503 for storing an executable code of methods or steps of the methods according to embodiments of the invention as well as the registers adapted to record variables and parameters necessary for implementing the methods; and
at least two communication interfaces 1502 and 1502′ connected to the wireless communication network, for example a communication network according to one of the IEEE 802.11 family of standards, via transmitting and receiving antennas 1504 and 1504′, respectively.

Preferably the communication bus 1513 provides communication and interoperability between the various elements included in the communication device 1500 or connected to it. The representation of the bus is not limiting and in particular the central processing unit is operable to communicate instructions to any element of the communication device 1500 directly or by means of another element of the communication device 1500.

The executable code may be stored in a memory that may either be read only, a hard disk or on a removable digital medium such as for example a disk. According to an optional variant, the executable code of the programs can be received by means of the communication network, via the interface 1502 or 1502′, in order to be stored in the memory of the communication device 1500 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Although embodiments in the above description involve declaring eligible EMLMR links in the capabilities fields of ML Association Request frames, multiple EMLMR modes with multiple separate/disjoint EMLMR links sets can also be managed and simultaneously activated without previous declaration of the eligible EMLMR links. This applies for instance to the processes of FIGS. 4, 9a to 13: a non-AP MLD may activate two or more EMLMR modes to be active at the same time, with respective and separate EMLMR links sets.

The non-AP MLD may merely decide activating separately and independently two (or more) EMLMR modes, each one with a separate and disjoint EMLMR links set. In that case, the two EMLMR modes may be simultaneously active.

As an example, the AP MLD may initiate the activation of an EMLMR mode while another one is already active with another (and disjoint) EMLMR link set at the non-AP MLD or may initiate the simultaneous activation of two EMLMR modes with two separate EMLMR links sets. In that case, the AP MLD may send, to a non-AP MLD, a first EML OM Notification frame defining a proposal to activate or modify an EMLMR mode with a proposed EMLMR links set, while another EMLMR mode with a separate EMLMR links set is already active. The other active EMLMR mode may have been activated upon a previous proposal from the AP MLD. In a variant, the two (or more) EMLMR modes with separate EMLMR links sets can be simultaneously activated upon proposal from the AP MLD.

The non-AP MLD receiving an EML OM Notification frame with a proposed EMLMR links set may decide whether the proposal is relevant and, in the affirmative, send an EML OM Notification frame including the proposed EMLMR links set to actually activate or modify the EMLMR mode with the AP MLD.

1. A communication method in a wireless network, comprising at a requesting multi-link device, MLD:
sending, to a requested MLD, an Enhanced Multi-Link, EML, Operating Mode, OM, notification frame including an EML Control field, the EML Control field comprising an EML Mode subfield set to indicate that an EML mode is disabled for a set of EML links;
wherein the communication method further comprises selecting a link from the set of EML links for which the EML mode is disabled,
wherein the notification frame is sent over the link selected from the set of EML links for which the EML mode is disabled.

2. The method of claim 1, wherein, prior to the sending, the EML mode is enabled for the set of EML links.

3. The method of claim 1, wherein, prior to the sending, the EML mode is enabled simultaneously for a plurality of sets of EML links, including the set of EML links for which the EML mode is disabled.

4. The method of claim 3, wherein the plurality of sets of EML links are disjoint sets of EML links.

5. The method of claim 2, wherein the EML mode is enabled for a target set of EML links by sending, to the requested MLD, an EML OM notification frame that includes an EML Control field, the EML Control field comprising an EML Mode subfield set to indicate that the EML mode is enabled for the target set of EML links and a bitmap subfield specifying the target set of EML links.

6. The method of claim 1, wherein the EML OM notification frame is deprived of a bitmap specifying the set of EML links for which the EML mode is disabled.

7. A communication method in a wireless network, comprising at a requested multi-link device, MLD:
receiving, from a requesting MLD, an Enhanced Multi-Link, EML, Operating Mode, OM, notification frame including an EML Control field, the EML Control field comprising an EML Mode subfield set to indicate that an EML mode is disabled for a set of EML links; and
determining the set of EML links for which the EML mode is disabled based on the link over which the EML OM notification frame is received.

8. The method of claim 1, wherein the EML mode is one of an EML Multi-Radio, MR, mode or an EML Single-Radio, SR, mode.

9. The method of claim 8, wherein the EML Control field includes an EMLMR Mode subfield and an EMLSR Mode subfield, and wherein the EMLMR, respectively EMLSR, Mode subfield is set to 0 to indicate that an EMLMR, respectively EMLSR, mode is disabled.

10. The method of claim 1, further comprising setting up links between the requesting and requested MLDs and enabling setup links, wherein the links in the set of EML links are enabled links.

11. A communication method in a wireless network, comprising at a requesting multi-link device, MLD:
sending, to a requested MLD, multiple Enhanced Multi-Link, EML, Operating Mode, OM, notification frames, each including an EML Control field, the EML Control field comprising an EML Mode subfield set to indicate that an EML mode is enabled for a set of EML links and a bitmap subfield specifying the set of EML links;
wherein the EML mode is enabled simultaneously for two or more sets of EML links provided that these two or more sets of EML links are disjoint.

12. A communication method in a wireless network, comprising at a requested multi-link device, MLD:
receiving, from a requesting MLD, multiple Enhanced Multi-Link, EML, Operating Mode, OM, notification frames, each including an EML Control field, the EML Control field comprising an EML Mode subfield set to indicate that an EML mode is enabled for a set of EML links and a bitmap subfield specifying the set of EML links;
wherein the EML mode is enabled simultaneously for two or more sets of EML links provided that these two or more sets of EML links are disjoint.

13. The method of claim 11, wherein the EML mode is one of an EML Multi-Radio, MR, mode or an EML Single-Radio, SR, mode.

14. The method of claim 13, wherein the EML Control field includes an EMLMR Mode subfield and an EMLSR mode subfield, and wherein the EMLMR, respectively EMLSR, Mode subfield is set to 1 to indicate that an EMLMR, respectively EMLSR, mode is enabled.

15. A requesting Multi-Link Device, MLD, comprising a memory and a processing circuitry coupled to the memory, the processing circuitry being configured to:
send, to a requested MLD, an Enhanced Multi-Link, EML, Operating Mode, OM, notification frame including an EML Control field, the EML Control field comprising an EML Mode subfield set to indicate that an EML mode is disabled for a set of EML links;
wherein the processing circuitry is further configured to select a link from the set of EML links for which the EML mode is disabled and to send the notification frame over the link selected from the set of EML links for which the EML mode is disabled.

16. A requested Multi-Link Device, MLD, comprising a memory and a processing circuitry coupled to the memory, the processing circuitry being configured to:
receive, from a requesting MLD, an Enhanced Multi-Link, EML, Operating Mode, OM, notification frame including an EML Control field, the EML Control field comprising an EML Mode subfield set to indicate that an EML mode is disabled for a set of EML links; and
determine the set of EML links for which the EML mode is disabled based on the link over which the EML OM notification frame is received.

17. A requesting Multi-Link Device, MLD, comprising: a memory and a processing circuitry coupled to the memory, the processing circuitry being configured to:
send, to a requested MLD, multiple Enhanced Multi-Link, EML, Operating Mode, OM, notification frames, each including an EML Control field, the EML Control field comprising an EML Mode subfield set to indicate that an EML mode is enabled for a set of EML links and a bitmap subfield specifying the set of EML links; wherein the EML mode is enabled simultaneously for two or more sets of EML links provided that these two or more sets of EML links are disjoint.

18. A requested Multi-Link Device, MLD, comprising: a memory and a processing circuitry coupled to the memory, the processing circuitry being configured to:
receive, from a requesting MLD, multiple Enhanced Multi-Link, EML, Operating Mode, OM, notification frames, each including an EML Control field, the EML Control field comprising an EML Mode subfield set to indicate that an EML mode is enabled for a set of EML links and a bitmap subfield specifying the set of EML links;
wherein the EML mode is enabled simultaneously for two or more sets of EML links provided that these two or more sets of EML links are disjoint.

19. A non-transitory computer-readable medium storing a program which, when executed by a microprocessor or computer system in a wireless device, causes the wireless device to perform the communication method of claim.

20. The method of claim 7, wherein the EML mode is one of an EML Multi-Radio, MR, mode or an EML Single-Radio, SR, mode.

21. The method of claim 20, wherein the EML Control field includes an EMLMR Mode subfield and an EMLSR Mode subfield, and wherein the EMLMR, respectively EMLSR, Mode subfield is set to 0 to indicate that an EMLMR, respectively EMLSR, mode is disabled.

22. The method of claim 7, further comprising setting up links between the requesting and requested MLDs and enabling setup links, wherein the links in the set of EML links are enabled links.
